(19) United States
(12) Patent Application Publication
(10) Pub. No.: US 2026/0057226 A1
(43) Pub. Date: Feb. 26, 2026

(54) OUTLIER REMOVAL FOR TRANSFORMER NETWORK QUANTIZATION

(71) Applicant: Texas Instruments Incorporated, Dallas, TX (US)

(72) Inventors: Parakh Agarwal, Ghaziabad (IN); Manu Mathew, Bangalore (IN); Varun Tripathi, Gurgaon (IN)

(21) Appl. No.: 18/977,615

(22) Filed: Dec. 11, 2024

(30) Foreign Application Priority Data
Aug. 26, 2024 (IN) 202441064556

(51) Int. Cl. G06N 3/0495; G06N 3/045

(52) U.S. Cl. CPC G06N 3/0495; G06N 3/045

(57) ABSTRACT

An example apparatus is to clip a value of an activation associated with a layer of a floating-point version of a machine learning model to determine a clipped value of the activation, the value of the activation based on calibration data applied to the floating-point version of the machine learning model. The example apparatus is also to determine, using the clipped value of the activation, a quantization factor to quantize activations associated with a corresponding layer of a fixed-point version of the machine learning model. The example apparatus is further to configure the fixed-point version of the machine learning model on a device using the quantization factor.

### CROSS-REFERENCE TO RELATED APPLICATIONS

This patent application claims the benefit of and priority to Indian Provisional Patent Application No. 202441064556, filed Aug. 26, 2024, which Application is hereby incorporated herein by reference in its entirety.

This patent application also incorporates the following commonly assigned patent applications by reference in their respective entireties: (i) U.S. Patent Publication No. 2024/0036816, titled “Systems and Methods for Identifying Scaling Factors for Deep Neural Networks,” published Feb. 1, 2024; (ii) U.S. Patent Publication No. 2024/0062059, titled “Neural Network Layer Optimization,” published Feb. 22, 2024; (iii) U.S. patent application Ser. No. 18/408,351, titled “Quantization of Neural Networks,” filed Jan. 9, 2024; and (iv) U.S. patent application Ser. No. 18/917,252, titled “Optimization of Transformer Encoders,” filed Oct. 16, 2024.

### TECHNICAL FIELD

This description relates generally to machine learning and, more particularly, to outlier removal for transformer network quantization.

### BACKGROUND

Deep machine learning models, such as deep neural networks (DNNs), are used for a variety of computer vision tasks, such as object detection, image segmentation, image classification, etc. A transformer network is a type of DNN that utilizes a transformer encoder to perform various tasks, such as computer-vision tasks, language processing tasks, audio processing tasks, and the like. Input to a transformer network includes sensor data, such as data from cameras and other image sensors, light detecting and ranging (LiDAR) sensors, radar sensors, etc., which can support applications such as machine vision, industrial inspection, advanced driver assistance, autonomous driving, etc. The output of the transformer network is task dependent. For example, if the transformer network is configured to perform image classification, then the input to the transformer network will include image data and the output of the transformer network will include a classification of the input image.

Machine learning models, such as transformer networks, DNNs, etc., may be trained based on floating-point implementations of such models, which utilize floating-point operations to process floating-point data. Such floating-point machine learning models may be designed for implementation on a cloud-based platform or other high-performance target platform having sufficient processing and memory capabilities to perform the floating-point operations of the model. However, an embedded device, such as an embedded system-on-chip (SoC) device, may be the preferred target platform on which to deploy the trained machine learning model. Such embedded devices may have limited processor and memory capabilities and, thus, may be designed to perform fixed-point operations on fixed-point data. Model quantization refers to the process of converting a floating-point implementation of a machine learning model to a corresponding fixed-point implementation, which involves converting the precision of the weights and activations of the model from floating-point precision to fixed-point precision.

### SUMMARY

For methods and apparatus to perform outlier removal for transformer network quantization, an example non-transitory computer-readable medium described herein includes example computer readable instructions to cause at least one processor circuit to at least clip a value of an activation associated with a layer of a floating-point version of a machine learning model to determine a clipped value of the activation, the value of the activation based on calibration data applied to the floating-point version of the machine learning model. The example instructions also cause one or more of the at least one processor circuit to determine, using the clipped value of the activation, a quantization factor to quantize activations associated with a corresponding layer of a fixed-point version of the machine learning model. The example instructions further cause one or more of the at least one processor circuit to configure the fixed-point version of the machine learning model on a device using the quantization factor.

For methods and apparatus to perform outlier removal for transformer network quantization, an example apparatus described herein includes interface circuitry, machine readable instructions, and at least one processor circuit to be programmed based on the machine readable instructions to clip a value of an activation associated with a layer of a floating-point version of a machine learning model to determine a clipped value of the activation, the value of the activation based on calibration data applied to the floating-point version of the machine learning model. One or more of the at least one processor circuit is also to determine, using the clipped value of the activation, a quantization factor to quantize activations associated with a corresponding layer of a fixed-point version of the machine learning model. One or more of the at least one processor circuit is further to configure the fixed-point version of the machine learning model on a device using the quantization factor.

For methods and apparatus to perform outlier removal for transformer network quantization, an example method described herein includes clipping a value of an activation associated with a layer of a floating-point version of a machine learning model to determine a clipped value of the activation, the value of the activation based on calibration data applied to the floating-point version of the machine learning model. The example method also includes determining, using the clipped value of the activation, a quantization factor to quantize activations associated with a corresponding layer of a fixed-point version of the machine learning model. The example method further includes configuring the fixed-point version of the machine learning model on a device using the quantization factor.

### BRIEF DESCRIPTION OF THE DRAWINGS

FIGS. 1A-1B illustrate an example operational environment including an example transformer network.

FIG. 2 illustrates an example method for executing a transformer network.

FIGS. 3A-3C illustrate a system representative of an example transformer network configured to perform image classification.

FIG. 4 is a block diagram of an example environment in which example model quantizer circuitry operates to quantize a trained floating-point machine learning model.

FIG. 5 illustrates an example quantization operation.

FIG. 6 illustrates example quantization factors determined by the model quantizer circuitry of FIG. 4.

FIG. 7 illustrates example activation data observed at various layers of an example machine learning model.

FIG. 8 illustrates an example function used by the model quantizer circuitry of FIG. 4 to perform outlier removal for quantization of a trained floating-point machine learning model.

FIG. 9 illustrates example types of quantization performed by the model quantizer circuitry of FIG. 4.

FIGS. 10-11 are flowcharts representative of example machine-readable instructions or example operations that may be at least one of executed, instantiated, or performed using an example programmable circuitry implementation of the model quantizer circuitry of FIG. 4.

FIG. 12 illustrates example model quantization performance results achieved by the model quantizer circuitry of FIG. 4.

FIG. 13 illustrates example advantages of the model quantizer circuitry of FIG. 4.

FIG. 14 is a block diagram of an example processing platform including programmable circuitry structured to execute, instantiate, or perform the example machine-readable instructions or perform the example operations of FIGS. 10-11 to implement the model quantizer circuitry of FIG. 4.

FIG. 15 is a block diagram of an example implementation of the programmable circuitry of FIG. 14.

FIG. 16 is a block diagram of another example implementation of the programmable circuitry of FIG. 14.

FIG. 17 is a block diagram of an example software/firmware/instructions distribution platform (e.g., one or more servers) to distribute software, instructions, or firmware (e.g., corresponding to the example machine-readable instructions of FIGS. 10-11) to client devices associated with end users or consumers (e.g., for license, sale, or use), retailers (e.g., for sale, re-sale, license, or sub-license), or original equipment manufacturers (OEMs) (e.g., for inclusion in products to be distributed to, for example, retailers or to other end users such as direct buy customers).

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Technology is disclosed herein to improve the accuracy of quantized machine learning models, such as quantized transformer networks, by removing outliers during model quantization. A transformer network is a type of deep learning network which is designed for various applications. For example, a transformer network may be trained to perform image segmentation, image classification, object detection, language processing or another deep learning task of the like. Determining a trained machine learning model, such as a trained transformer network, may involve training a floating-point implementation of the machine learning mode, which includes weights and activations having floating-point precision. Quantization of a trained machine learning model involves converting the weights and activations of the model from floating-point precision to fixed-point precision to generate a corresponding fixed-point implementation of the machine learning model.

In at least some examples, the fixed-point weights and activations of the fixed-point machine learning model are represented with fewer bits (e.g., 8 bits in some examples) than the floating-point weights and activations of the floating-point machine learning model (e.g., 32 bits in some examples). As a result, the quantized, fixed-point machine learning model may exhibit increased error and/or decreased accuracy relative to the original, floating-point machine learning model. This is because the fixed-point weights and activations of the fixed-point machine learning model have fewer bits to represent the ranges of the floating-point weights and activations of the floating-point machine learning model. Also, the presence of outliers in the values of the floating-point machine learning model's observed weights and activations may further increase the range of values to be represented by the fixed-point machine learning model's weights and activations, which may contribute to a further increase in model error and/or decrease in model accuracy.

As described in detail below, example model quantization techniques disclosed herein remove outliers in the values of the floating-point machine learning model's weights and activations observed during quantization. By removing such outliers, the range of values to be represented by the fixed-point machine learning model's weights and activations is reduced, which can result in improved model error and/or model accuracy relative to other model quantization techniques.

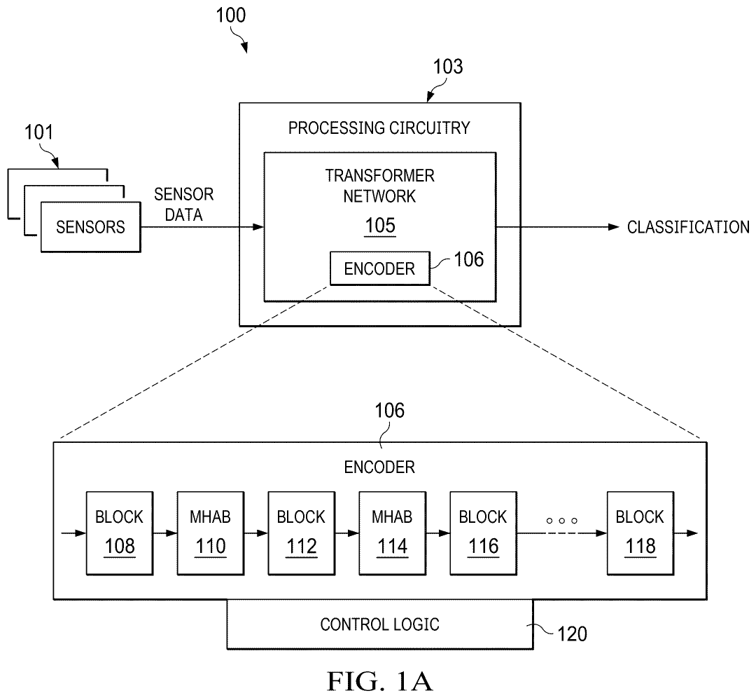

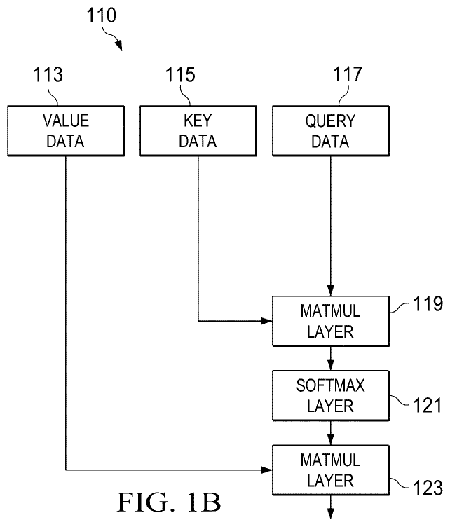

Turning to the figures, FIG. 1A illustrates an example operating environment 100 that is configurable to execute a transformer network. For example, operating environment 100 may be representative of a system configured to perform a computer-vision task such as image classification, object detection, or another task of the like. Operating environment 100 may be implemented in a variety of use-cases such as automotive, industrial, robotics, building automation, language processing, power electronics, autonomous systems, radar, image processing, audio processing, or another application of the like which requires computer-vision and/or processing of other data (e.g., text data, language data, audio signals, radar signals, etc.). Operating environment 100 includes, but is not limited to, sensors 101 and processing circuitry 103.

Example sensors 101 are representative of sensors configured to collect input data for executing a transformer network. For example, sensors 101 may be representative of cameras, radar devices, or another sensor of the like configured to collect sensor data for executing transformer network 105. In an implementation, sensors 101 are configured to collect image data or other sensor data of an environment. For example, sensors 101 may be representative of cameras which are mounted on a car and configured to collect image data of the car's surrounding environment. For the purposes of explanation, image data will be discussed herein. This is not meant to limit the applications of the proposed technology, but rather to provide an example. Sensors 101 are coupled to processing circuitry 103 and configured to output image data to processing circuitry 103.

Example processing circuitry 103 is representative of circuitry configured to execute a transformer network. For example, processing circuitry 103 may be representative of a central processing unit (CPU), application-specific integrated circuit (ASIC), digital signal processor (DSP), microcontroller unit (MCU), graphics processing unit (GPU), tensor processing unit (TPU), or another general-purpose processor (GPP) of the like. Processing circuitry 103 includes, but is not limited to, transformer network 105.

Example transformer network 105 is representative of a deep learning network configured to perform a designated task. Input to transformer network 105 includes sensor data, while the output of transformer network 105 is task dependent. For example, if transformer network 105 is configured to perform image classification, then sensors 101 may collect image data of an environment and provide the image data to transformer network 105. In response, transformer network 105 may output a classification for the image data. Transformer network 105 includes encoder 106.

Example encoder 106 is representative of a transformer encoder which is configured to employ attention mechanisms for executing the task which transformer network 105 is configured to perform. An attention mechanism describes a technique for determining the relative importance of features captured by the image data of sensors 101. In an implementation, encoder 106 utilizes multi-headed attention mechanisms to execute transformer network 105. A multi-headed attention mechanism is representative of a type of attention mechanism which causes a transformer encoder to analyze different features of the input data simultaneously. Encoder 106 includes, but is not limited to, example block 108, example multi-headed attention block (MHAB) 110, example block 112, example MHAB 114, example block 116, example block 118 and example control logic 120.

Block 108 is representative of a processing block which is configured to generate input data for executing a multi-headed attention mechanism of encoder 106. For example, block 108 may be configured to generate the input data for executing MHAB 110. In an implementation, to generate the input data for executing MHAB 110, block 108 is configured to embed the image data of sensors 101 into a number of image matrices. For example, block 108 may receive image data from sensors 101, divide the image data into a number of image patches, embed those image patches into an equal number of image matrices, and supply the number of image matrices as input to MHAB 110. In response, MHAB 110 is configured to apply weight values to the number of image matrices to generate input data for executing the multi-headed attention mechanism of MHAB 110. For example, MHAB 110 may apply key weights, query weights, and value weights to each image matrix to generate key data, query data, and value data for each of the image matrices.

The query data of an image matrix is representative of a matrix which describes the perspective of the image matrix within the input image. For example, the query data may signify that the image matrix represents the first image matrix of the input image. The key data of an image matrix is representative of a matrix which describes the relationship between the image matrix and other image matrices within the input image. For example, the key data may signify that the image matrix comprises data which correlates to the data of other image matrices of the input image. The value data of an image matrix is representative of a matrix which describes the actual data of the image matrix. For example, the value data may store the data of the image matrix.

MHAB 110 is representative of a processing block which is configured to execute a series of attention-based operations on the query data, key data, and value data of each image matrix. For example, MHAB 110 may be configured to calculate the scaled dot-product attention for each image matrix of the input image. The scaled dot-product attention is representative of an attention mechanism for determining the normalized attention scores of an image matrix. In an implementation, to determine the scaled dot-product attention of each image matrix, MHAB 110 executes a series of layers, such that the first layer is representative of a matrix multiplication layer, the second layer is representative of a SoftMax layer, and the third layer is representative of another matrix multiplication layer, later discussed in detail with reference to FIG. 1B.

Output of MHAB 110 includes a final attention scores matrix. The final attention scores matrix is representative of a matrix which stores the final attention scores for each image matrix of the original input image. For example, if the input image was divided into four image matrices, then the output of MHAB 110 represents a matrix which stores the final attention scores of the four image matrices. In an implementation, MHAB 110 is configured to provide its output to block 112.

Block 112 is representative of a processing block which is configured to generate input data for executing another multi-headed attention mechanism of encoder 106. For example, block 112 may be configured to generate the input data for executing MHAB 114. In an implementation, to generate the input data for executing MHAB 114, block 112 is configured to normalize the output of MHAB 110 and supply the normalized output to MHAB 114. For example, block 112 may comprise a normalization layer configured to normalize the final attention scores matrix of MHAB 110 and supply the normalized matrix to MHAB 114. In response, MHAB 114 is configured to apply weight values to the normalized matrix to generate input data for executing the multi-headed attention mechanism of MHAB 114. For example, MHAB 114 may apply key weights, query weights, and value weights to the normalized matrix to generate key data, query data, and value data for the normalized matrix.

MHAB 114 is representative of a processing block which is configured to execute a series of attention-based operations on the query data, key data, and value data of the normalized attention matrix. For example, MHAB 114 may also comprise multiple layers for computing the scaled dot-product attention, such that the first layer represents a matrix multiplication layer, the second layer represents a SoftMax layer, and the third layer represents another matrix multiplication layer. Output of MHAB 114 includes a final attention scores matrix. The final attention scores matrix of MHAB 114 is representative of a matrix which stores the final attention scores for the output of block 112. In an implementation, MHAB 114 is configured to provide its output to block 116.

Block 116 is representative of another processing block which is configured to generate input data for executing another multi-headed attention mechanism of encoder 106. For example, block 116 may be representative of block 112. In an implementation, block 116 is configured to normalize the output of MHAB 114 and supply the normalized output to the next layer of encoder 106. For example, block 116 may comprise a normalization layer configured to normalize the final attention scores matrix of MHAB 114 and supply the normalized matrix to a next MHAB of encoder 106. It should be noted that encoder 106 may comprise more than two MHABs, but for the purposes of explanation, only two were illustrated herein.

Block 118 is representative of a processing block which is configured to form the output of encoder 106. For example, block 118 may receive a final attention scores matrix from a previous MHAB of the network and normalize the final attention scores matrix of the MHAB to generate the output of encoder 106. In an implementation, the output of encoder 106 is supplied to a next layer of transformer network 105 which is configured to form an output for transformer network 105. For example, if transformer network 105 is configured to perform image classification, then block 118 may supply its output to a multi-layer perceptron (MLP) network configured to classify the input image. Alternatively, if transformer network 105 is configured to perform object detection, then block 118 may supply its output to an object detection network configured to output a warning when an object is detected, when multiple different objects are detected, etc.

Control logic 120 is representative of software, executed by processing circuitry 103 for managing the execution of encoder 106. For example, processing circuitry 103 may execute control logic 120 to cause encoder 106 to execute the multi-headed attention mechanisms for performing the task of transformer network 105.

FIG. 1B illustrates the layers of MHAB 110 in an example implementation. The layers of MHAB 110 are representative of processing layers which are configured to determine the scaled dot-product attention of an image matrix through a series of fixed-point computations. In an implementation, MHAB 110 is configured to offload the fixed-point computations of its processing layers to an associated hardware accelerator. For example, processing circuitry 103 may be coupled to a hardware accelerator configured to execute the various fixed-point computations of operating environment 100. MHAB 110 includes, but is not limited to, example matrix multiplication layer 119, example SoftMax layer 121, and example matrix multiplication layer 123. It should be noted that FIG. 1B further illustrates the layers of MHAB 114, but for the purposes of explanation, only the layers of MHAB 110 will be discussed herein.

Matrix multiplication layer 119 represents the first processing layer of MHAB 110. Input to matrix multiplication layer 119 includes the key data 115 and query data 117 of an associated image matrix, while the output includes a first result matrix. The first result matrix is representative of a matrix which stores the attention scores of the associated image matrix. The attention scores are representative of data which assigns a relevance to the associated image matrix in comparison to the other image matrices of the input image.

In an implementation, to perform the matrix multiplication operation of matrix multiplication layer 119, processing circuitry 103 is configured to instruct an associated hardware accelerator to execute the operation. For example, processing circuitry 103 may instruct the hardware accelerator to perform a matrix multiplication operation with respect to the key data 115 and query data 117 of an associated image matrix. In response, the hardware accelerator is configured to read in the key data 115 from memory and write the key data 115 to a left matrix input of the matrix multiplication operation, and transpose-read in the query data 117 from memory and write the transpose-read query data to a right matrix input of the matrix multiplication operation. Once written, the hardware accelerator is configured to produce the first result matrix by matrix multiplying the left matrix input with the right matrix input.

In an implementation, matrix multiplication layer 119 is configured to perform the matrix multiplication operation for each image matrix of an input image. For example, if an input image is embedded into four image matrices, then matrix multiplication layer 119 is configured to cause the hardware accelerator to generate four first result matrices, such that each first result matrix corresponds to one of the four image matrices of the input image. In another implementation, matrix multiplication layer 119 is configured to perform the matrix multiplication operation for each input matrix that was supplied to matrix multiplication layer 119. For example, if matrix multiplication layer 119 is supplied with six input matrices from a previous layer of encoder 106 (e.g., MHAB), then matrix multiplication layer 119 is configured to cause the hardware accelerator to generate six corresponding result matrices. Once generated, matrix multiplication layer 109 is configured to supply its output to SoftMax layer 121.

SoftMax layer 121 represents the second processing layer of MHAB 110. Input to SoftMax layer 121 includes a first result matrix, while the output includes a result of the SoftMax operation. A SoftMax operation is representative of a fixed-point computation for normalizing the attention scores produced by matrix multiplication layer 119. Meaning, the output of the SoftMax operation is representative of a second result matrix which stores the normalized attention scores of the first image matrix. It should be noted that some transformer networks employ operations other than SoftMax to normalize the attention scores of the first matrix multiplication operation. Such examples may be found in the following publications, “SimA: Simple SoftMax-free Attention for Vision Transformers” written by Soroush Koohpayegani et al., “SofterMax: Hardware/Software Co-Design of an Efficient SoftMax for Transformers” written by Jacob Stevens et al., and “Replacing SoftMax with ReLU in Vision Transformers” written by Mitchell Wortsman et al., which are hereby incorporated by reference in their entirety.

In an implementation, to perform the SoftMax operation of SoftMax layer 121, processing circuitry 103 is configured to instruct an associated hardware accelerator to execute the fixed-point computations of the SoftMax operation. For example, processing circuitry 103 may instruct the hardware accelerator to execute a height-wise SoftMax operation with respect to the first result matrix of an associated image matrix. In response, the hardware accelerator may generate a second result matrix for the associated image matrix. In an implementation, after generating the second result matrix, the hardware accelerator is configured to transpose-write the second result matrix to memory. For example, after executing the SoftMax operation of SoftMax layer 121, the hardware accelerator may transpose-write the result of the SoftMax operation to an associated memory.

In an implementation, SoftMax layer 121 is configured to perform the SoftMax operation for each output of matrix multiplication layer 119. For example, if matrix multiplication layer 119 outputs four first result matrices, then SoftMax layer 121 is configured to cause the hardware accelerator to generate four second result matrices. Once generated, SoftMax layer 121 is configured to supply its output to matrix multiplication layer 123.

Matrix multiplication layer 123 represents the third processing layer of MHAB 110. Input to matrix multiplication layer 123 includes the transpose-written second result matrix and the value data 113 of an associated image matrix, while the output includes a third result matrix. The third result matrix is representative of a matrix which stores the final attention scores of an associated image matrix.

In an implementation, to perform the matrix multiplication operation of matrix multiplication layer 123, processing circuitry 103 is configured to instruct an associated hardware accelerator to execute the operation. For example, processing circuitry 103 may instruct the hardware accelerator to perform a matrix multiplication operation with respect to the transpose-written second result matrix and the value data 113 of an associated image matrix. In response, the hardware accelerator is configured to read in the transpose-written second result matrix from memory and write the transpose-written second result matrix to a left matrix input of the matrix multiplication operation and, read in the value data 113 from memory and write the value data 113 to a right matrix input of the matrix multiplication operation. Once written, the hardware accelerator is configured to produce the third result matrix by matrix multiplying the left matrix input with the right matrix input.

In an implementation, matrix multiplication layer 123 is configured to perform the matrix multiplication operation on each output of SoftMax layer 121. For example, if SoftMax layer 121 outputs four second result matrices, then matrix multiplication layer 123 is configured to cause the hardware accelerator to generate four third result matrices. Once generated, matrix multiplication layer 123 is configured to supply its output to a next layer of transformer network 105. For example, matrix multiplication layer 123 may supply the third result matrices to a layer configured to generate a fourth result matrix by summing together the data of the third result matrices.

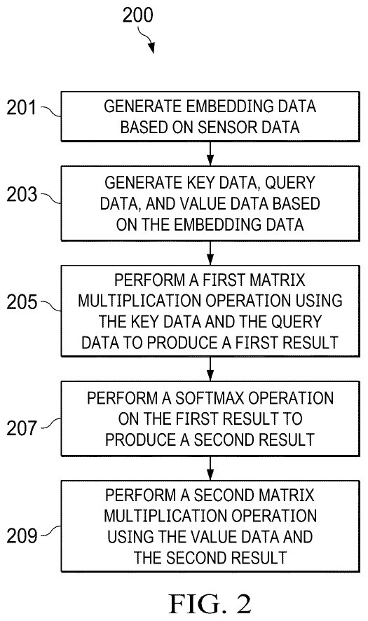

FIG. 2 illustrates an example method 200 for executing a transformer network. Method 200 may be implemented in the context of software or program instructions that, when executed by a suitable computing system, direct the processing circuitry of the computing system to operate as follows, referring parenthetically to the steps in FIG. 2. For the purposes of explanation, method 200 will be explained with the elements of FIGS. 1A and 1B. This is not meant to limit the applications of scheduling method 200, but rather to provide an example.

To begin, block 108 generates embedding data based on the sensor data collected by sensors 101 (corresponding to block 201 of FIG. 2). For example, block 108 may receive image data from sensors 101, divide the image data into a number of patches, embed those patches into an equal number of image matrices, and supply the image matrices as input to MHAB 110. In response, MHAB 110 generates key data 115, query data 117, and value data 113 for each of the input matrices (corresponding to block 203 of FIG. 2). For example, MHAB 110 may apply key weights, query weights, and value weights to each of the embedded patches to generate key data 115, query data 117, and value data 113 for each embedded patch.

Next, MHAB 110 is configured to execute matrix multiplication layer 119 (corresponding to block 205 of FIG. 2). In an implementation, matrix multiplication layer 119 is executed by an associated hardware accelerator. For example, the hardware accelerator may be configured to read in key data 115 of a first embedded patch from memory and write the key data 115 to a left matrix input of the matrix multiplication operation. The hardware accelerator may be further configured to transpose-read query data 117 of the first embedded patch from memory and write the transpose-read query data 117 to a right matrix input of the matrix multiplication operation. Finally, the hardware accelerator may be configured to produce a first result by performing the matrix multiplication operation with respect to the left matrix input and the right matrix input.

The first result is representative of a matrix which stores the attention scores for the corresponding embedded patch. In an implementation, the hardware accelerator is configured to generate a first result for each embedded patch received by MHAB 110. For example, if MHAB 110 received six different embedded patches, then the hardware accelerator is configured to generate a first result matrix for each of the six embedded patches.

Next, matrix multiplication layer 119 outputs the first results to memory, and in response, MHAB 110 is configured to execute SoftMax layer 121 (corresponding to block 207 of FIG. 2). In an implementation, SoftMax layer 121 is executed by an associated hardware accelerator. For example, the associated hardware accelerator may be configured to read in the first results from memory and execute a height-wise SoftMax operation on each of the first results to generate a set of second results. The set of second results are representative of matrices which store normalized attention scores for each of the first results, and more specifically, for each embedded patch.

In an implementation, the associated hardware accelerator is configured to transpose-write the second results to memory. For example, if the output of the SoftMax layer includes six different second results, then the hardware accelerator is configured to transpose-write each of the six different second results to memory. Once stored by the memory, MHAB 110 is triggered to execute matrix multiplication layer 123 (corresponding to block 209 of FIG. 2).

In an implementation, matrix multiplication layer 123 is executed by an associated hardware accelerator. For example, the hardware accelerator may be configured to read in the transpose-written second result of an embedded patch from memory and write the transpose-written second result to a left matrix input of the matrix multiplication operation. The hardware accelerator may be further configured to read in the value data 113 of the first embedded patch from memory and write the value data 113 to a right matrix input of the matrix multiplication operation. Finally, the hardware accelerator is configured to produce a third result by performing the matrix multiplication operation with respect to the left matrix input and the right matrix input.

The third result is representative of a matrix which stores the final attention scores for the corresponding embedded patch. In an implementation, the hardware accelerator is configured to generate a third result for each of the embedded patches. For example, if MHAB 110 received six different embedded patches, then the hardware accelerator is configured to generate a third result matrix for each of the six embedded patches.

Once generated, matrix multiplication layer 123 is configured to supply the generated third results to a next layer of transformer network 105. For example, matrix multiplication layer 123 may supply the third results to a layer configured to sum the data of the third results to generate a fourth result. The fourth result is representative of a matrix which stores the final attention scores of each of the embedded patches. In an implementation, the fourth result is supplied to block 112.

Advantageously, method 200 takes advantage of the transpose-read and transpose-write capabilities of the hardware accelerator, thereby improving the efficiency of the transformer network. Furthermore, method 200 supplies the key data 115 as a left matrix input to the first matrix multiplication operation and supplies the transpose-read query data as a right matrix input to the first matrix multiplication operation thusly allowing the hardware accelerator to perform a height-wise SoftMax operation, rather than a width-wise SoftMax operation. As a result, method 200 provides a technique for efficiently executing the layers of a transformer encoder, which thereby optimizes the execution of the transformer network.

A height-wise SoftMax operation can be more efficient than a width-wise SoftMax operation. SoftMax is an operation which can see input data of [h×K×K] (in this example 3×197×197) as a series of independent h×K vectors and each of length K. Each of these vectors has to perform SoftMax and produce the same length of vector as output. Softmax involves finding a maximum within the vector for numerical stabilization and hence includes intra-vector operations which are not very suitable for single instruction, multiple data (SIMD) architectures. A height-wise SoftMax operation involves performing a SoftMax on a set of vectors instead of on single vector at a time. This can be maintained without any overhead from the producer of this data. SoftMax has multiple intermediate steps, and SoftMax can allow the final output to be in original layout (h×K×K) output without any additional cost. SoftMax can happen on a series of vectors preventing the need for intra-vector operations. SoftMax can happen on h×K vectors allowing large number of vectors and allowing better utilization of architectures with larger SIMD width.

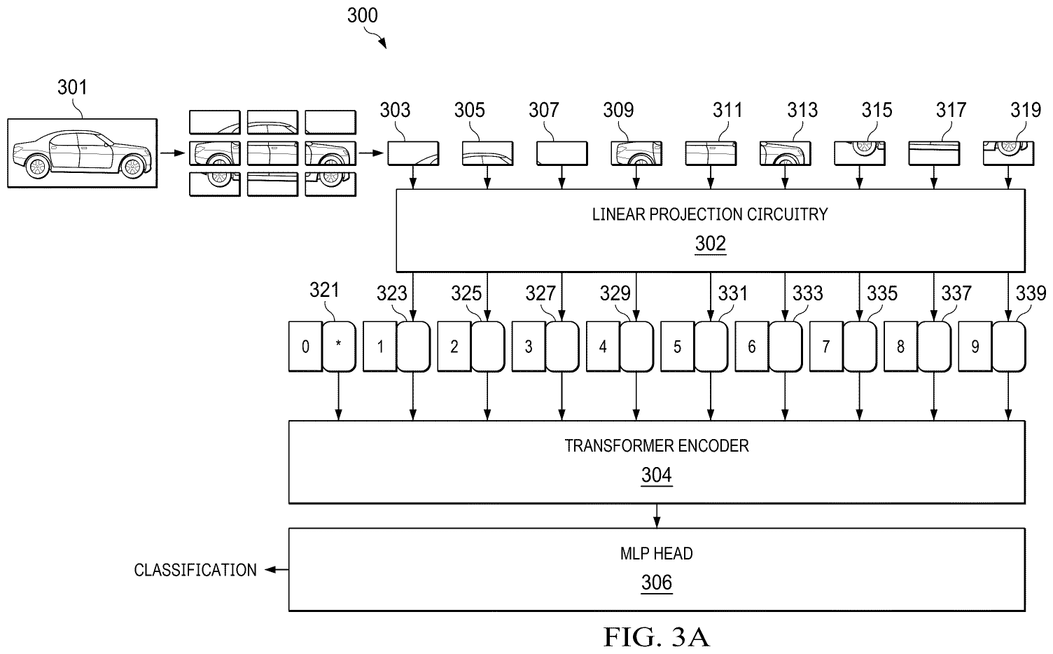

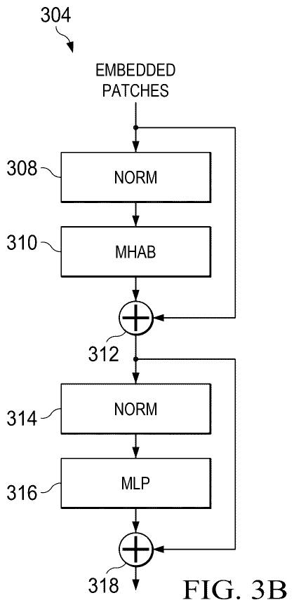

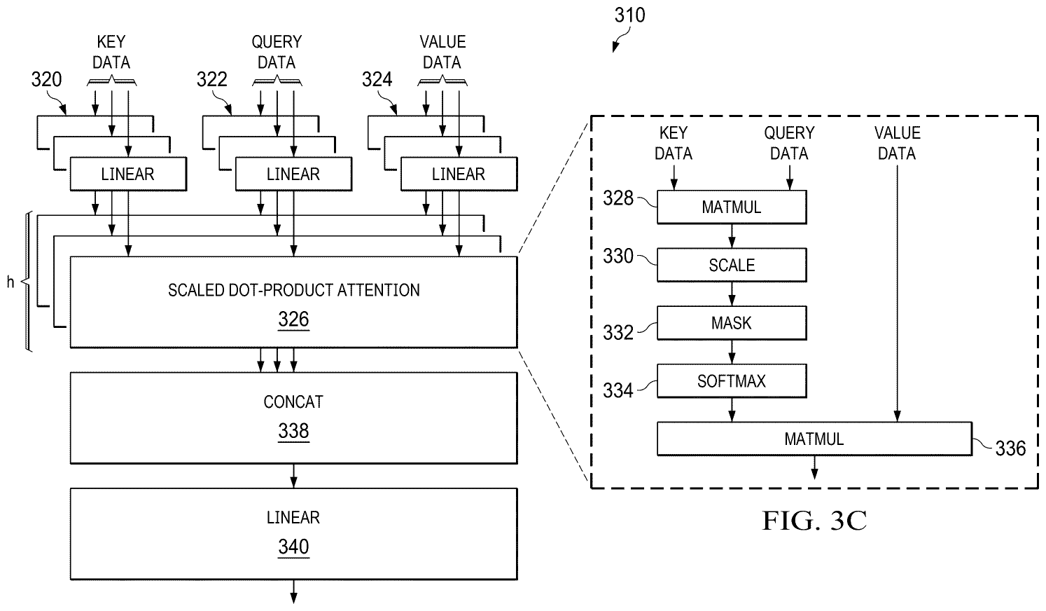

Now turning to the next figure, FIG. 3A illustrates and example system 300 representative of a transformer network configured to perform image classification. For example, system 300 may be representative of transformer network 105 of FIG. 1A. System 300 includes, but is not limited to, example image 301, example linear projection circuitry 302, example transformer encoder 304, and example multi-layer perceptron (MLP) network 306.

Image 301 represents the input data for a transformer network. For example, system 300 may be coupled to a camera configured to collect image data of an environment. In an implementation, image 301 is representative of image data collected by a car. For example, a car may include multiple cameras configured to collect image data of the surrounding environment (e.g., cars, pedestrians, etc.) and supply the image data to system 300. In response, system 300 is configured to divide image 301 into a number of patches, herein represented by example image patches 303, 305, 307, 309, 311, 313, 315, 317 and 319. Image patches 303, 305, 307, 309, 311, 313, 315, 317 and 319 represent sections of image data which correspond to image 301. In an implementation, image patches 303, 305, 307, 309, 311, 313, 315, 317 and 319 are provided as input to linear projection circuitry 302.

Linear projection circuitry 302 is representative of circuitry configured to embed image data into a format which may be provided to a transformer encoder. For example, linear projection circuitry 302 may be configured to embed image patches 303, 305, 307, 309, 311, 313, 315, 317 and 319 into representations which may be fed to transformer encoder 304. In an implementation, linear projection circuitry 302 is configured to embed image patches 303, 305, 307, 309, 311, 313, 315, 317 and 319 into image matrices. In another implementation, linear projection circuitry 302 is configured to embed image patches 303, 305, 307, 309, 311, 313, 315, 317 and 319 into image vectors. In either case, the output of linear projection circuitry 302 includes example embedded patches 323, 325, 327, 329, 331, 333, 335, 337, and 339.

Embedded patches 323, 325, 327, 329, 331, 333, 335, 337, and 339 represent patches of embedded image data. For example, embedded patches 323, 325, 327, 329, 331, 333, 335, 337, and 339 may represent matrices which correspondingly store embedded image data of image patches 303, 305, 307, 309, 311, 313, 315, 317 and 319. For the purposes of explanation, embedded patches 323, 325, 327, 329, 331, 333, 335, 337, and 339 represent image matrices. This is not meant to limit the applications of the proposed technology, but rather to provide an example.

In an implementation, prior to outputting the embedded patches, linear projection circuitry 302 is configured to label embedded patches 323, 325, 327, 329, 331, 333, 335, 337, and 339 with positional embeddings. For example, linear projection circuitry may sequentially label the embedded patches, such that embedded patch 323 is labeled as “1”, embedded patch 325 is labeled as “2”, and so on. Once labeled, linear projection circuitry 302 may provide embedded patches 323, 325, 327, 329, 331, 333, 335, 337, and 339 as input to transformer encoder 304.

Transformer encoder 304 is representative of a deep learning architecture which is configured to employ attention mechanisms for performing the task of system 300. For example, transformer encoder 304 may be representative of encoder 106 of FIG. 1A. In an implementation, transformer encoder 304 employs multi-headed attention mechanisms to perform image classification, later discussed in detail with reference to FIG. 3B.

Input to transformer encoder 304 includes the output of linear projection circuitry 302, as well as example classification embedding 321. Classification embedding 321 is representative of learnable data generated during the training stage of system 300. For example, if system 300 is trained to classify images within the automotive context, then classification embedding 321 may provide data which allows transformer encoder 304 to classify vehicles, pedestrians, traffic lights, and other surroundings of the like. In an implementation, linear projection circuitry 302 is configured to label classification embedding 321 with a positional embedding. For example, linear projection circuitry may label classification embedding as “0”. It should be noted that classification embedding 321 may represent an alternative learnable embedding (e.g., detection embedding), but for the purposes of explanation, classification embedding 321 will be discussed herein.

In an implementation, transformer encoder receives classification embedding 321 and embedded patches 323, 325, 327, 329, 331, 333, 335, 337, and 339, and in response, generates an attention-based output. For example, transformer encoder 304 may generate a matrix which stores the final attention scores for image 301. The final attention scores represent data that assigns a relevance to the image data captured by image 301. The relevance of the image data describes the importance of the image data within the context of the task that system 300 is configured to perform. In an implementation, after generating the final attention scores matrix, transformer encoder 304 is configured to provide its output to MLP network 306.

MLP network 306 is representative of a deep learning network which is configured to form the output of system 300. For example, MLP network 306 may comprise multiple layers configured to classify the data of image 301. In an implementation, MLP network 306 is configured to classify image 301 based on the output of transformer encoder 304. For example, MLP network 306 may classify image 301 as a car based on the final attention scores matrix generated by transformer encoder 304.

FIG. 3B illustrates example layers of transformer encoder 304 in an implementation. The layers of transformer encoder 304 are representative of processing layers which are configured to perform various attention-based operations. For example, the layers may execute operations for performing multi-headed attention mechanisms and scaled dot-product attention mechanisms.

In an implementation, transformer encoder 304 is configured to offload the fixed-point computations of its processing layers to an associated hardware accelerator. For example, system 300 may be coupled to a hardware accelerator configured to execute the various fixed-point computations of the transformer network. Transformer encoder 304 includes, but is not limited to, example normalization layer 308, example multi-headed attention block (MHAB) 310, example summation layer 312, example normalization layer 314, example multi-layer perceptron (MLP) 316, and example summation layer 318.

Normalization layer 308 is representative of a processing layer which is configured to generate input data for executing a multi-headed attention mechanism of transformer encoder 304. For example, normalization layer 308 may be representative of block 108 of FIG. 1A. In an implementation, normalization layer 308 is configured to normalize the data of embedded patches 323, 325, 327, 329, 331, 333, 335, 337, and 339 and supply the normalized patches to MHAB 310. In response, MHAB 310 is configured to apply various weight values to the normalized patches to generate key data, query data, and value data for embedded patches 323, 325, 327, 329, 331, 333, 335, 337, and 339.

The query data of an embedded patch is representative of a matrix which describes the perspective of the patch within the input image. For example, the query data of embedded patch 323 may signify that embedded patch 323 represents image patch 303 of image 301. The key data of an embedded patch is representative of a matrix which describes the relationship between the patch and other patches within the input image. For example, the key data of embedded patch 323 may signify that embedded patch 323 comprises image data which corresponds to embedded patches 305 and 309. The value data of an embedded patch is representative of a matrix which describes the actual data of the patch. For example, the value data of embedded patch 323 may store the image data of image patch 303.

MHAB 310 is representative of a processing block configured to execute a multi-headed attention mechanism. For example, MHAB 310 may be representative of MHAB 110 or MHAB 114 of FIG. 1A. In an implementation, MHAB 310 comprises multiple processing layers which are configured to calculate the scaled dot-product attention for each image matrix of the input image. For example, MHAB 310 may include a first matrix multiplication layer (e.g., matrix multiplication layer 119), a SoftMax layer (e.g., SoftMax layer 121), and a second matrix multiplication layer (e.g., matrix multiplication layer 123), later discussed in detail with reference to FIG. 3C. Output of MHAB 310 is provided as input to summation layer 312.

Summation layer 312 is representative of a processing layer which is configured to sum the output of MHAB 310 with the data of embedded patches 323, 325, 327, 329, 331, 333, 335, 337, and 339. In an implementation, the summation operation of summation layer 312 is performed by the associated hardware accelerator. For example, the associated hardware accelerator may sum the output of MHAB 310 with the data of embedded patches 323, 325, 327, 329, 331, 333, 335, 337, and 339. Output of summation layer 312 is provided to normalization layer 314.

Normalization layer 314 is representative of a processing layer which is configured to normalize the output of summation layer 312. For example, normalization layer 314 may normalize the final attention score matrix of image 301. Output of normalization layer 314 is provided to MLP 316.

MLP 316 is representative of a processing block which is configured to linearize the output of normalization layer 314. For example, MLP 316 may linearize the final attention score matrix of image 301. Meaning, MLP 316 may store the data of the final attention score matrix linearly in memory. Output of MLP 316 is provided as input to summation layer 318.

Summation layer 318 is representative of a processing layer which is configured to sum the output of summation layer 312 with the output of MLP 316. For example, summation layer 318 may sum the final attention score matrix of image 301 with the linearized data. In an implementation, the summation operation of summation layer 318 is performed by the associated hardware accelerator. For example, the associated hardware accelerator may sum the output of summation layer 312 with the data of final attention scores matrix. In an implementation, output of summation layer 318 is provided to MLP network 306. In another implementation, the output of summation layer 318 is provided to a next layer of encoder 304. For example, summation layer 318 may provide its output to a normalization layer configured to generate input data for executing another multi-headed attention mechanism of encoder 304. It should be noted that encoder 304 may comprise multiple MHABs configured to determine the scaled dot-product attention of its input.

Additional example details for executing the layers of transformer encoders within the context of transformer networks may be found in the following publication, entitled “An Image is Worth 16×16 Words: Transformers for Image Recognition at Scale” written by Alexey Dosovitskiy et al.

FIG. 3C illustrates example layers of MHAB 310 in an implementation. The layers of MHAB 310 are representative of processing layers which are configured to determine the scaled dot-product attention of an image matrix through a series of fixed-point computations. The scaled dot-product attention is representative of an attention mechanism for determining the normalized attention scores of an input image. MHAB 310 includes, but is not limited to, example linearization layers 320, 322, and 324, example scaled dot-product attention (SDPA) block 326, example concatenation layer 338, and example linearization layer 340.

Linearization layers 320, 322, and 324 are correspondingly representative of processing layers which are configured to linearize the key data, query data, and value data of embedded patches within memory. For example, linearization layers 320, 322, and 324, may be configured to correspondingly linearize the key data, query data, and value data of embedded patches 323, 325, 327, 329, 331, 333, 335, 337, and 339 in memory. In an implementation, linearization layers 320, 322, and 324 each include a number of processing layers such that the number of processing layers is equal to the number of supplied embedded patches. For example, linearization layers 320 include nine processing layers for linearizing the key data of embedded patches 323, 325, 327, 329, 331, 333, 335, 337, and 339. Similarly, linearization layers 322 and 324 include nine processing layers for correspondingly linearizing the query data and value data of embedded patches 323, 325, 327, 329, 331, 333, 335, 337, and 339. In an implementation, the linearization operations of linearization layers 320, 322, and 324 are performed by an associated hardware accelerator. Output of linearization layers 320, 322, and 324 is supplied to SDPA block 326.

SDPA block 326 is representative of a processing block which is configured to determine the scaled dot-product attention of embedded data. For example, SDPA block 326 may be configured to determine the scaled dot-product attention of embedded patches 323, 325, 327, 329, 331, 333, 335, 337, and 339. In an implementation, SDPA block includes a number of SDPA processing layers, such that the number of SDPA processing layers is equal to the number of supplied embedded patches. For example, SDPA block 326 may include nine processing layers for determining the scaled-dot-product attention of embedded patches 323, 325, 327, 329, 331, 333, 335, 337, and 339. In an implementation, each SDPA processing layer of SDPA block 326 includes example matrix multiplication layer 328, example scale layer 330, example mask layer 332, example SoftMax layer 334, and example matrix multiplication layer 336.

Matrix multiplication layer 328 is representative of a processing layer configured to perform a matrix multiplication operation with respect to the key data and query data of an embedded patch. For example, matrix multiplication layer 328 may be representative of matrix multiplication layer 119 of FIG. 1B. In an implementation, the matrix multiplication operation of matrix multiplication layer 328 is performed by an associated hardware accelerator. For example, system 300 may include a hardware accelerator configured to execute the fixed-point computations of SDPA block 326.

In an implementation, to perform the matrix multiplication operation of matrix multiplication layer 328, the hardware accelerator is configured to read in the linearized key data of an embedded patch from memory and write the linearized key data to a left matrix input of the matrix multiplication operation. Next, the hardware accelerator is configured to transpose-read in the linearized query data of the embedded patch from memory and write the transpose-read query data to a right matrix input of the matrix multiplication operation. Once written, the hardware accelerator is configured to produce a first result matrix by matrix multiplying the left matrix input with the right matrix input. The first result matrix is representative of a matrix which stores the attention scores of the embedded patch (e.g., embedded patch 323). In an implementation, matrix multiplication layer 328 is configured to supply the first result matrix to scale layer 330.

Scale layer 330 is representative of a processing layer configured to scale the output of matrix multiplication layer 328. For example, scale layer 330 may be configured to format the data of the first result matrix into a representation which is better suited for executing SoftMax layer 334 by applying a scaling value to the first result matrix. In an implementation, the scaling operation of scale layer 330 is executed by an associated hardware accelerator. For example, the associated hardware accelerator may be configured to apply the scaling value to the first result matrix. Output of scale layer 330 is supplied to mask layer 332 (or SoftMax layer 334).

Mask layer 332 is representative of an optional processing layer which is configured to mask the output of scale layer 330. For example, mask layer 332 may be configured to format the output of scale layer 330 into a representation which is better suited for executing SoftMax layer 334 by masking the invalid values of the scaled first result matrix. In an implementation, the masking operation of mask layer 332 is executed by an associated hardware accelerator. For example, the associated hardware accelerator may be configured to mask the invalid data of the scaled first result matrix. Output of mask layer 332 is supplied to SoftMax layer 334. It should be noted that, if SDPA block 326 does not include mask layer 332, then scale layer 330 is configured to supply its output to SoftMax layer 334.

SoftMax layer 334 is representative of a processing layer configured to perform a SoftMax operation. For example, SoftMax layer 334 may be representative of SoftMax layer 121 of FIG. 1B. In an implementation, the SoftMax operation of SoftMax layer 334 is performed by the associated hardware accelerator. For example, the associated hardware accelerator may be configured to execute a height-wise SoftMax operation with respect to the output of mask layer 332 (or scale layer 330) to generate a second result matrix. The second result matrix is representative of a matrix which stores the normalized attention scores of the first result matrix. In an implementation, after generating the second result matrix, the hardware accelerator is configured to transpose-write the second result matrix to memory. For example, after executing the SoftMax operation of SoftMax layer 334, the associated hardware accelerator may transpose-write the second result matrix to memory. Once written, SoftMax layer 334 is configured to provide the transpose-written second result matrix as input to matrix multiplication layer 336.

Matrix multiplication layer 336 is representative of a processing layer configured to perform a matrix multiplication operation with respect to the transpose-written second result and the value data of an embedded patch. For example, matrix multiplication layer 336 may be representative of matrix multiplication layer 123 of FIG. 1B. In an implementation, the matrix multiplication operation of matrix multiplication layer 336 is performed by an associated hardware accelerator. For example, the associated hardware accelerator may be configured to read in the transpose-written second result matrix from memory and write the transpose-written second result matrix to a left matrix input of the matrix multiplication operation. Next, the hardware accelerator may be configured to read in the value data of an embedded patch from memory and write the value data to a right matrix input of the matrix multiplication operation. Once written, the hardware accelerator is configured to produce a third result matrix by matrix multiplying the left matrix input with the right matrix input.

The third result matrix is representative of a matrix which stores the final attention scores of the embedded patch. In an implementation the third result matrix of each embedded patch is supplied as input to concatenation layer 338. For example, after SDPA block 326 generates the third result matrices for each patch of embedded patches 323, 325, 327, 329, 331, 333, 335, 337, and 339, SDPA block 326 may supply each third result matrix to concatenation layer 338.

Concatenation layer 338 is representative of a processing layer configured to concatenate the output of SDPA block 326 into a singular matrix. For example, concatenation layer 338 may concatenate the third result matrices of embedded patches 323, 325, 327, 329, 331, 333, 335, 337, and 339 into a singular matrix. In an implementation, the concatenation operation of concatenation layer 338 is performed by an associated hardware accelerator. Output of concatenation layer 338 is suppled as input to linearization layer 340.

Linearization layer 340 is representative of processing layer configured to linearize the output of concatenation layer 338. For example, linearization layer 340 may receive the output matrix of concatenation layer 338, and in response, linearize the data of the output matrix in memory. In an implementation, the linearization operation of linearization layer 340 is performed by an associated hardware accelerator. Output of linearization layer 340 is supplied to summation layer 312.

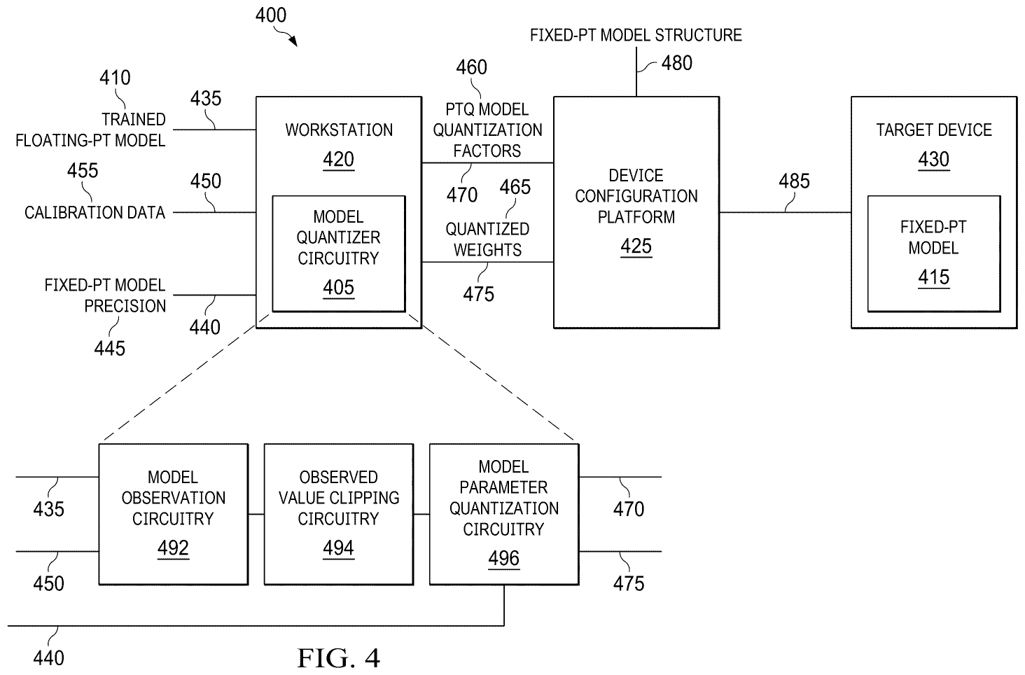

FIG. 4 is a block diagram of an example environment 400 in which example model quantizer circuitry 405 operates to quantize an example trained floating-point machine learning model 410 to generate a corresponding example fixed-point machine learning model 415. The model quantizer circuitry 405 of FIG. 4 may be instantiated (e.g., creating an instance of, bring into being for any length of time, materialize, implement, etc.) by programmable circuitry such as a Central Processor Unit (CPU) executing first instructions. Also or alternatively, the model quantizer circuitry 405 of FIG. 4 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 4 may, thus, be instantiated at the same or different times. Some or all of the circuitry of FIG. 4 may be instantiated, for example, in one or more threads executing concurrently on hardware or in series on hardware. Moreover, in some examples, some or all of the circuitry of FIG. 4 may be implemented by microprocessor circuitry executing instructions or FPGA circuitry performing operations to implement one or more virtual machines or containers.

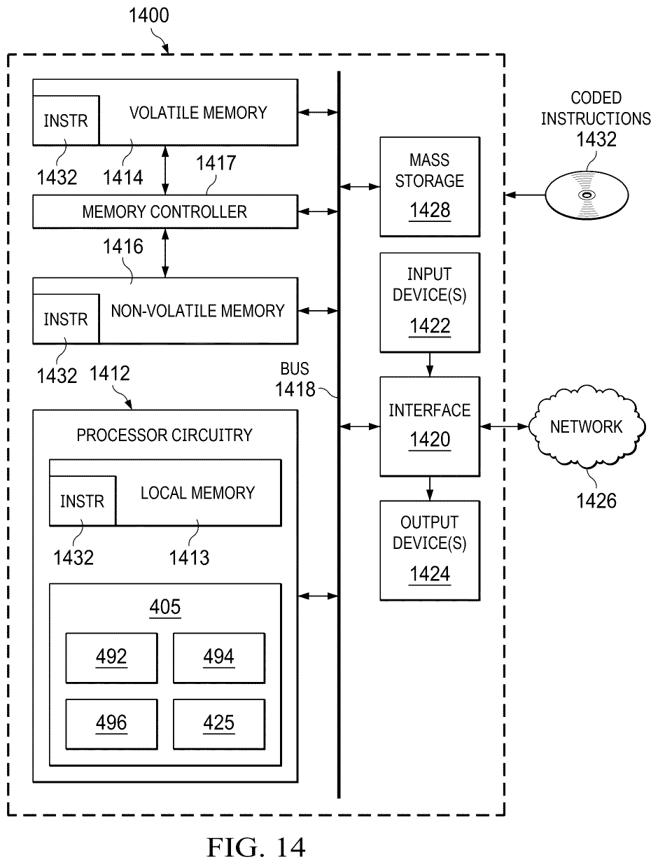

In the illustrated example of FIG. 4, the environment 400 includes an example workstation 420, an example device configuration platform 425 and an example target device 430. In the illustrated example, the workstation 420 includes or otherwise implements the model quantizer circuitry 405. The workstation 420 can be implemented by any compute device, processor platform, computer, server, etc. In some examples, the workstation 420 is implemented by the example programmable circuitry platform 1400 of FIG. 14, which is described in further detail below.

In the illustrated example, the workstation 420 and, by extension, the model quantizer circuitry 405 include an example model input 435 to accept the trained floating-point model 410. In some examples, the model input 435 can be implemented by a network interface, a user input, etc., to accept the trained floating-point model 410 in the form or one or more data files, data structures, etc., that specify the structure of the various layers of the model 410, as well as the values of the trained weights, biases and/or other parameters of the various layers of the model 410. For example, the trained floating-point model 410 may correspond to a transformer network, such as the transformer network 105 described above in connection with FIGS. 1A-3C, and the model input 435 may accept, retrieve or otherwise obtain one or more data files, data structures, etc., that specify the structure of the various layers of the transformer network 105, and the values of the trained weights, biases and/or other parameters of the various layers of the transformer network 105. In some examples, the trained floating-point model 410 may correspond to any other type of machine learning model, such as a neural network, a convolutional neural network, a reinforcement learning model, etc.

In the illustrated example, the workstation 420 and, by extension, the model quantizer circuitry 405 also include an example precision input 440 to accept example fixed-point model precision data 445 that specifies the precision of the weights and activations in the resulting fixed-point machine learning model 415. In some examples, the precision data 445 may specify the precision of the weights and activations in the various layers of the resulting fixed-point machine learning model 415 in the form of the number(s) of bits to be used represent the weights and activations in a given layer of fixed-point machine learning model 415. For example, the precision data 445 may specify that, for a given layer of the fixed-point machine learning model 415, the weights and activations of the layer are to be represented with eight (8) bits (or some other number of bits). In some examples, for a given layer of the fixed-point machine learning model 415, the precision data 445 may specify different numbers of bits to be used to represent the weights and activations of that layer. For example, the precision data 445 may specify that, for a given layer of the fixed-point machine learning model 415, the weights of the layer are to be represented with four (4) bits (or some other number of bits) and activations of the layer are to be represented with eight (8) bits (or some other number of bits different than the number of bits used to represent the weights).

In the illustrated example, the workstation 420 and, by extension, the model quantizer circuitry 405 further include an example calibration data input 450 to accept example calibration data 455 to be used by the model quantizer circuitry 405 to quantize the trained floating-point machine learning model 410 to generate the corresponding fixed-point machine learning model 415. In some examples, the calibration data 455 includes input data elements and corresponding ground truth inference results expected to be processed and output by the trained floating-point machine learning model 410. For example, if the trained floating-point machine learning model 410 corresponds to the transformer network 105 described above and is trained to perform image classification, then the calibration data may include a set of input images formatted to be input to the trained floating-point machine learning model 410 and a corresponding set of ground-truth inferred classifications expected to be output respectively by the trained floating-point machine learning model 410 for those input images.

As disclosed in further detail below, the model quantizer circuitry 405 processes the trained floating-point machine learning model 410, the precision data 445 and the calibration data 455 to output example quantization factors 460 to be used to quantize the weights and/or activations at the various layers of the floating-point machine learning model 410. At least part of this processing can involve performing inference using the trained floating-point machine learning model 410. For example, and as described in further detail below, the quantization factors 460 may include scale factors and offset factors to be used to quantize the weights and/or activations at the various layers of the floating-point machine learning model 410 to determine the quantized weights and/or activation for the corresponding layers of the fixed-point machine learning model 415. In some examples, the model quantizer circuitry 405 also uses the particular quantization factors 460 (e.g., scale factors and offset factors) determined for the weights at the various layers of the floating-point machine learning model 410 to output example quantized weights 465 for the corresponding layers of the fixed-point machine learning model 415.

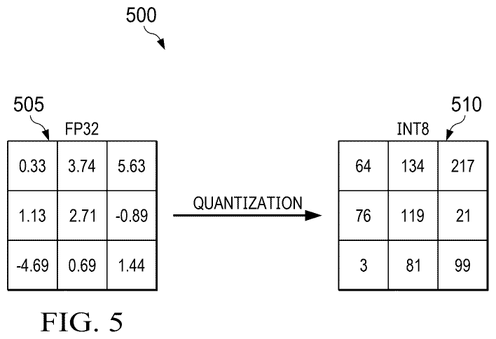

FIG. 5 illustrates an example quantization operation 500 performed by the model quantizer circuitry 405 of FIG. 4. In the illustrated example, the model quantizer circuitry 405 observes a set of example floating-point weights 505 for a given layer of the floating-point machine learning model 410. For example, the floating-point weights 505 may be represented as 32-bit floating-point values. The model quantizer circuitry 405 obtains (e.g., observes) the set of floating-point weights 505 by causing the floating-point machine learning model 410 to execute and process (e.g., perform inference on) at least a portion of the calibration data 455. As disclosed in further detail below, the model quantizer circuitry 405 determines quantization factors 460 that are used to quantize or, in other words, convert the set of floating-point weights 505 to a corresponding set of quantized, fixed-point weights 510. For example, the fixed-point weights 510 may be represented as 8-bit integer values.

Returning to the illustrated example of FIG. 4, the workstation 420 and, by extension, the model quantizer circuitry 405 include an example quantization factor output 470 to output the quantization factors 460 to the device configuration platform 425. In some examples, the workstation 420 and, by extension, the model quantizer circuitry 405 also include an example quantized weight output 475 to output the quantized weights 465 to the device configuration platform 425. The device configuration platform 425 operates to download, install or otherwise configure the fixed-point machine learning model 415 on the target device 430. The target device 430 can be any device capable of executing or otherwise implementing the fixed-point machine learning model 415. For example, the target device 430 can be an SoC device, an embedded processor device, a field programmable gate array (FPGA), an application specific integrated circuit (ASIC), a computer, a smartphone, a tablet device, etc., or any other compute device.

In the illustrated example, device configuration platform 425 accepts the quantization factors 460, the quantized weights 465 and an example fixed-point model structure 480. The fixed-point model structure 480 can be in the form or one or more data files, data structures, etc., that specify the structure of the various layers of the fixed-point machine learning model 415. In the illustrated example, the device configuration platform 425 uses the quantization factors 460, the quantized weights 465 to configure the fixed-point model structure 480 for operation on the target device 430. For example, the device configuration platform 425 communicates with the target device 430 via an example configuration interface 485 to download, install or otherwise configure the fixed-point model structure 480 on the target device 430. In some examples, the device configuration platform 425 also communicates with the target device 430 via the configuration interface 485 to populate the weights of the fixed-point model structure 480 on the target device 430 with the quantized weights 465. In some examples, the device configuration platform 425 also communicates with the target device 430 via the configuration interface 485 to populate activation quantization operations of the fixed-point model structure 480 on the target device 430 with the quantization factors 460 (e.g., which may yield channel-wise clip values for the fixed-point machine learning model 415, etc.). In some examples, after the fixed-point model structure 480 on the target device 430 is configured based on the quantized weights 465 and quantization factors 460, the device configuration platform 425 causes the target device 430 to enable execution of the resulting, populated fixed-point machine learning model 415.

As such, the device configuration platform 425 can be any platform capable of downloading, installing or otherwise configuring the fixed-point machine learning model 415 on the target device 430. For example, the device configuration platform 425 can implemented by a wireless transceiver and the configuration interface 485 can be a wireless interface to permit over-the-air configuration of the target device 130. In some examples, the device configuration platform 425 is implemented by an electronic design automation (EDA) tool and the configuration interface 485 can be a tool interface, such as a joint test action group (JTAG) interface, that communicates with the target device 130. In some examples, the device configuration platform 425 is implemented by a compute device, such as a computer, server, smartphone, etc., and the configuration interface 485 can be a communication interface, such as a serial port, a universal serial bus (USB), a wireless interface, etc., that communicates with the target device 130. In some examples, the device configuration platform 425 is included in or otherwise implemented by the workstation 420. In some examples, the device configuration platform 425 is included in or otherwise implemented by the model quantizer circuitry 405.

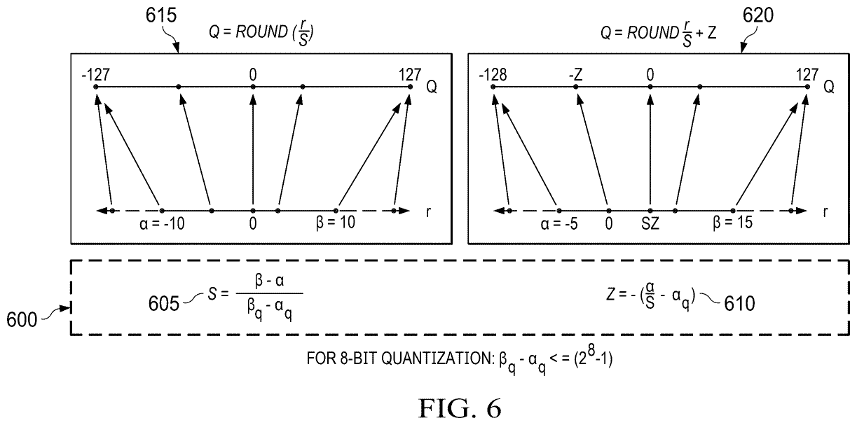

The example model quantizer circuitry 405 of FIG. 4 includes example model observation circuitry 492, example observed value clipping circuitry 494 and example model parameter quantization circuitry 496 to process the trained floating-point machine learning model 410, the precision data 445 and the calibration data 455 to generate the quantization factors 460 to be used to quantize the weights and/or activations at the various layers of the floating-point machine learning model 410 to generate the fixed-point machine learning model 415. In some examples, the model observation circuitry 492, the observed value clipping circuitry 494 and the model parameter quantization circuitry 496 implement a post training quantization (PTQ) algorithm that is enhanced to support data observation clipping, as described in further detail below. For example, FIG. 6 illustrates example quantization factors 600 determined by the model quantizer circuitry 405 and, more specifically, by the model parameter quantization circuitry 496 based on observation data obtained by the model observation circuitry 492 and the observed value clipping circuitry 494 of FIG. 4.

In general, for a given set of floating-point model parameters to be quantized, the model quantizer circuitry 405 determines a corresponding set of quantization factors 600. For example, for a given set of floating-point weights at a given layer of the trained floating-point machine learning model 410, the model quantizer circuitry 405 determines a corresponding set of quantization factors 600 that are used to quantize the set of floating-point weights to determine a corresponding set of floating-point weights for that layer of the fixed-point machine learning model 415. Similarly, for a given set of floating-point activations at a given layer of the trained floating-point machine learning model 410, the model quantizer circuitry 405 determines a corresponding, different set of quantization factors 600 that are used to quantize the set of floating-point activations to determine a corresponding set of fixed-point weights for that layer of the fixed-point machine learning model 415. Thus, for a given layer of the trained floating-point machine learning model 410, the model quantizer circuitry 405 may determine a first set of quantization factors 600 for the weights of that layer, and may determine a second set of quantization factors 600 for the activations of that layer.

As shown in FIG. 6, in some examples, a given set of quantization factors 600 includes an example scale factor 605. In some examples, the given set of quantization factors 600 also includes an example offset factor 610. The set of quantization factors 600 is used to configure a quantizer function, which performs a linear mapping to convert floating-point values in an input range of (α, β) to fixed-point, or integer, values in an output quantization range (α_{q}, β_{q}), where α corresponds to the minimum possible input value, β corresponds to the maximum possible input value, α_{q} corresponds to the minimum possible output value, and β_{q} corresponds to the maximum possible output value. Quantization generally reduces the processor and memory requirements of machine learning models, such as a transformer network and other types of neural networks, by decreasing the precision of the weights and activations of the machine learning model.

FIG. 6 illustrates two example quantizer functions 615 and 620 that can be configured by the set of quantization factors 600. The quantizer function 615 is an example of a symmetric quantizer that maps a symmetric floating-point input range (α, β) to a symmetric fixed-point, or integer, output range (α_{q}, β_{q}), with α==β and α_{q}=−β_{q}. The quantizer function 620 is an example of an asymmetric quantizer that can map an asymmetric floating-point input range (α, β) to an asymmetric fixed-point, or integer, output range (α_{q}, β_{q}), with α≠−β and α_{q}≠−β_{q}.

As illustrated in the example of FIG. 6, the model parameter quantization circuitry 496 computes the scale factor 605 based on the floating-point input range (α, β) and the fixed-point, or integer, output range (α_{q}, β_{q}) according to the ratio of Equation 1:

$$S = \frac{β - α}{{β}_{q} - {α}_{q}} \qquad Equation 1$$

In Equation 1, the size of the fixed-point, or integer, output range, β_{q}-α_{q}, is based on the precision of the fixed-point, or integer, values as specified by the fixed-point model precision data 445 applied to the precision input 440. If the precision for a particular set of fixed-point, or integer, values is specified by the precision data 445 to be b bits, then the size of the fixed-point, or integer, output quantization range, β_{q}-α_{q}, is given by Equation 2:

$${β}_{q} - {α}_{q} = {2}^{b} - 1 \qquad Equation 2$$

For example, if b is set to be 8-bit precision, then the quantized output range is given by Equation 3:

$${β}_{q} - {α}_{q} = {2}^{8} - 1 = 255 \qquad Equation 3$$

In some examples, the model parameter quantization circuitry 496 also computes the offset factor 610 based on the floating-point input range (α, β) and the fixed-point, or integer, output range (α_{q}, β_{q}) according to Equation 3:

$$Z = - ( \frac{α}{S} - {α}_{q} ) \qquad Equation 4$$

As shown in Equations 1 and 4 above, the quantization factors 600 and, more specification, the scale factor 605 and the offset factor 610, for a given set of floating-point values depend on the size of the floating-point input range, β-α, which depends on knowledge of the minimum possible input value, α, and the maximum possible input value, β. Returning to FIG. 4, the model observation circuitry 492 of the model quantizer circuitry 405 obtains the trained floating-point machine learning model 410 via the model input 435. The model observation circuitry 492 then inserts observer operations (also referred to as observer functions, observers, etc.) in the trained floating-point machine learning model 410 to observe the values of the floating-point weights and activations at various layers of the model 410. In the illustrated example, the model observation circuitry 492 also obtains at least a portion of the calibration data 455 via the calibration data input 450 and causes the trained floating-point machine learning model 410 to process (e.g., perform inference on) that calibration data 455. The model observation circuitry 492 then uses the inserted observer operations to collect the observed values for the floating-point weights and activations at various layers of the trained floating-point machine learning model 410 as the model 410 processes (e.g., performs inference on) the input calibration data 455.

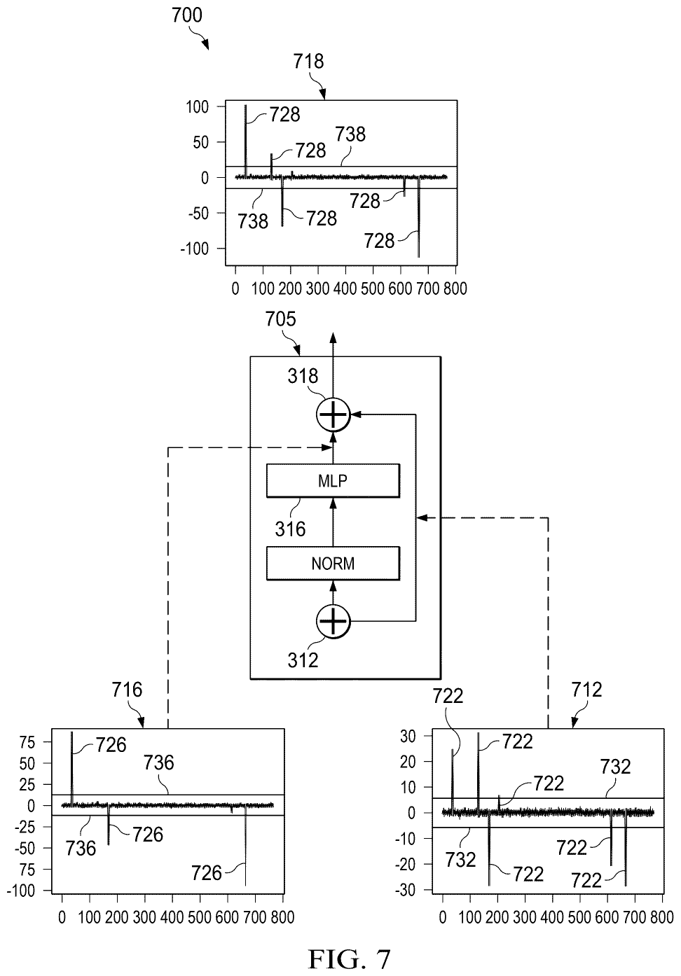

FIG. 7 illustrates example activation data 700 observed by the model observation circuitry 492 of the model quantizer circuitry 405 of FIG. 4 at the activation outputs of various example layers 705 of the trained, floating-point machine learning model 410. The model layers 705 correspond to the summation layer 312, the MLP layer 316 and the summation layer 318 of the transformer encoder 304 of FIG. 3B. In the illustrated example of FIG. 7, the model observation circuitry 492 inserts observer operations at the activation outputs of the summation layer 312, the MLP layer 316 and the summation layer 318 to observe respective example activation output data 712, 716 and 718 at those respective layers.

Using the observed activation data 712, it would be possible to determine minimum and maximum values (e.g., α₁, β₁) of the data 712 and compute a first set of quantization factors 600 (e.g., corresponding to a first scale factor S₁ and a first offset factor Z₁) using Equations 1 and 4 above, which could be used to quantize the activations at the summation layer 312. Similarly, using the observed activation data 716, it would be possible to determine minimum and maximum values (e.g., α₂, β₂) of the data 716 and compute a second set of quantization factors 600 (e.g., corresponding to a second scale factor S₂ and a second offset factor Z₂) using Equations 1 and 4 above, which could be used to quantize the activations at the MLP layer 316. Likewise, using the observed activation data 718, it would be possible to determine minimum and maximum values (e.g., α₃, β₃) of the data 718 and compute a third set of quantization factors 600 (e.g., corresponding to a third scale factor S₃ and a third offset factor Z₃) using Equations 1 and 4 above, which could be used to quantize the activations at the summation layer 318.

However, in the illustrated example of FIG. 7, the observed activation data 712, 716 and 718 include example outliers 722, 726 and 728, respectively, which increase the respective observed ranges of floating-point data to be quantized which, in turn, reduces the quantization accuracy. For example, it is more accurate to represent a smaller input 32-bit floating-point range of [0, 1] with an output 8-bit integer range of [0, 255] than it is to represent a larger input 32-bit floating-point range of [0,1000] with the same output 8-bit integer range of [0, 255]. Furthermore, having such outliers also negatively affects the precision of smaller quantized values and in turn may lead to incorrect predictions.

Thus, the model quantizer circuitry 405 of FIG. 4 includes the observed value clipping circuitry 494 to clip outlier values from the observed data obtained by the model observation circuitry 492 to improve quantization accuracy. For example, the observed value clipping circuitry 494 is able to clip the outliers 722, 726 and 728 from the observed activation data 712, 716 and 718, which decreases the overall ranges of the activation data 712, 716 and 718 to be quantized. In some examples, to perform such clipping, the observed value clipping circuitry 494 determines one or more clipping thresholds based on the observed floating-point values. For example, the observed value clipping circuitry 494 may determine one or more example clipping thresholds 732 based on the observed activation data 712. Likewise, the observed value clipping circuitry 494 may determine one or more example clipping thresholds 736 based on the observed activation data 716, and may determine one or more example clipping thresholds 738 based on the observed activation data 718.

For example, to determine the clipping threshold(s) 732, the observed value clipping circuitry 494 may determine one or more metrics using the observed activation data 712. For example, the metric(s) determined by the observed value clipping circuitry 494 from the observed activation data 712 may include a standard deviation, a variance or variance-based metric, a distribution-based metric, a dispersion metric, a skew metric, a percentile metric, etc. In some such examples, the observed value clipping circuitry 494 then clips the observed activation data 712 using the metric(s). In some such examples, the observed value clipping circuitry 494 may scale a computed metric by a number to determine a scaled metric, and then may clip the observed activation data 712 using the scaled metric. Likewise, the observed value clipping circuitry 494 may determine respective metric(s) using the observed activation data 716 and 718 and use those metric(s) to clip the observed activation data 716 and 718. FIG. 8 illustrates an example function 800 used by the observed value clipping circuitry 494 of the model quantizer circuitry 405 of FIG. 4 to perform outlier removal for quantization of the trained floating-point machine learning model.

Turning to FIG. 8, to use the function 800 to determine the clipping threshold(s) 732, for the observed activation data 712, the observed value clipping circuitry 494 determines a first metric that is the standard deviation of the observed activation data 712 (represented by x_{std} in FIG. 8). The observed value clipping circuitry 494 also determines a second metric that is the mean, or average value, of the observed activation data 712 (represented by xₘₑₐₙ in FIG. 8). The observed value clipping circuitry 494 then uses the mean and standard deviation metrics to determine the clipping thresholds 732 which, in the illustrated example, include an example upper clipping threshold 805 and an example lower clipping threshold 810. For example, the observed value clipping circuitry 494 determines the upper clipping threshold 805 to be the result of adding the standard deviation multiplied by a number (e.g., the number “3” in FIG. 8, or some other number such as two or four, etc.) to the mean. In this example, the observed value clipping circuitry 494 determines the lower clipping threshold 810 to be the result of subtracting the standard deviation multiplied by a number (e.g., the number “3” in FIG. 8, or some other number) from the mean. In some examples, using the number “3” to scale the standard deviation is referred to as a three-sigma approach for determining the clipping thresholds. In some examples, the observed value clipping circuitry 494 performs similar operations using the function 800 to determine the respective clipping thresholds 736 and 738 for the observed activation data 716 and 718.

Using the function 800, the observed value clipping circuitry 494 then clips values of the observed activation data 712 (represented by “x” in FIG. 8) that are greater than the upper clipping threshold 805 by setting those values equal to the upper clipping threshold 805. Similarly, using the function 800, the observed value clipping circuitry 494 clips values of the observed activation data 712 that are lower than the lower clipping threshold 810 by setting those values equal to the lower clipping threshold 810. Furthermore, the observed value clipping circuitry 494 leaves values of the observed activation data 712 between the upper clipping threshold 805 and the lower clipping threshold 810 unchanged. If all values of the observed activation data 712 are between or within the thresholds 805 and 810, the observed value clipping circuitry 494 may be configured to not clip any values of the observed activation data 712. The resulting clipped values of the observed activation data (represented by “x_{new}” in FIG. 8) are then used by the model parameter quantization circuitry 496 to determine the quantization factors 600 (e.g., the scale factor 605 and the offset factor 610) to be used to quantize the activation data of the corresponding layer 312 in the fixed-point machine learning model 415. In some examples, the observed value clipping circuitry 494 performs similar operations using the function 800 to clip the observed activation data 716 and 718 based on the respective clipping thresholds 736 and 738. The resulting clipped values are then used by the model parameter quantization circuitry 496 to determine the quantization factors 600 to be used to quantize the activation data of the corresponding layers 316 and 318 in the fixed-point machine learning model 415.

Although the model observation circuitry 492, the observed value clipping circuitry 494 and the model parameter quantization circuitry 496 have been described from the perspective of quantization activation data of a given layer of the machine learning model 410, the model observation circuitry 492, the observed value clipping circuitry 494 and the model parameter quantization circuitry 496 can also be used to quantize the weights of a given layer in a similar manner. Thus, in summary, the model observation circuitry 492 of the model quantizer circuitry 405 obtains the trained floating-point machine learning model 410 and the calibration data 455 as inputs. The model observation circuitry 492 also inserts observer operations to observe the values of the activations and weights at various layers of the trained floating-point machine learning model 410 as it processes the calibration data. The observed value clipping circuitry 494 of the model quantizer circuitry 405 clips the observed activation data and the observed weights at the various layers of the trained floating-point machine learning model 410 using metrics determined for the observed activation data and metrics determined for the observed weights. For example, the observed value clipping circuitry 494 can clip the observed activation data for a given model layer using the function 800 of FIG. 8 and the metrics determined for the observed activation data. Similarly, the observed value clipping circuitry 494 can clip the observed weights for the given model layer using the function 800 of FIG. 8 and the metrics determined for the observed weight data. In some examples, the observed value clipping circuitry 494 also causes the clipped activation data at the output of given layer to propagate to the next model layer (e.g., instead of causing the unclipped data to propagate) as the trained floating-point machine learning model 410 processes the calibration data 455. By blocking the propagation of outlier activations, the observed value clipping circuitry 494 may be able to reduce the prevalence of outliers in subsequent model layers.

Next, the model parameter quantization circuitry 496 uses the resulting clipped activation data for the given model layer to determine the quantization factors 600 (e.g., the scale factor 605 and the offset factor 610) to be used to quantize the activations data for the corresponding layer of the fixed-point machine learning model 415. The model parameter quantization circuitry 496 also includes the quantization factors 600 for the activation data of the given layer in the quantization factors 460 output via the quantization factor output 470. Likewise, the model parameter quantization circuitry 496 uses the resulting clipped weight values for the given model layer to determine the quantization factors 600 (e.g., the scale factor 605 and the offset factor 610) to be used to quantize the weights for the corresponding layer of the fixed-point machine learning model 415. In some examples, the model parameter quantization circuitry 496 also includes the quantization factors 600 for the weights of the given layer in the quantization factors 460 output via the quantization factor output 470. In some examples, if the trained weights of a given model layer do not change during processing of the calibration data 455, the model parameter quantization circuitry 496 also uses the quantization factors 600 (e.g., the scale factor 605 and the offset factor 610) for the weights to configure an instance of the quantizer functions 615 or 620. The model parameter quantization circuitry 496 then uses the configured function 615 or 620 to quantize the weights for the given model layer for output via the quantized weight output 475.

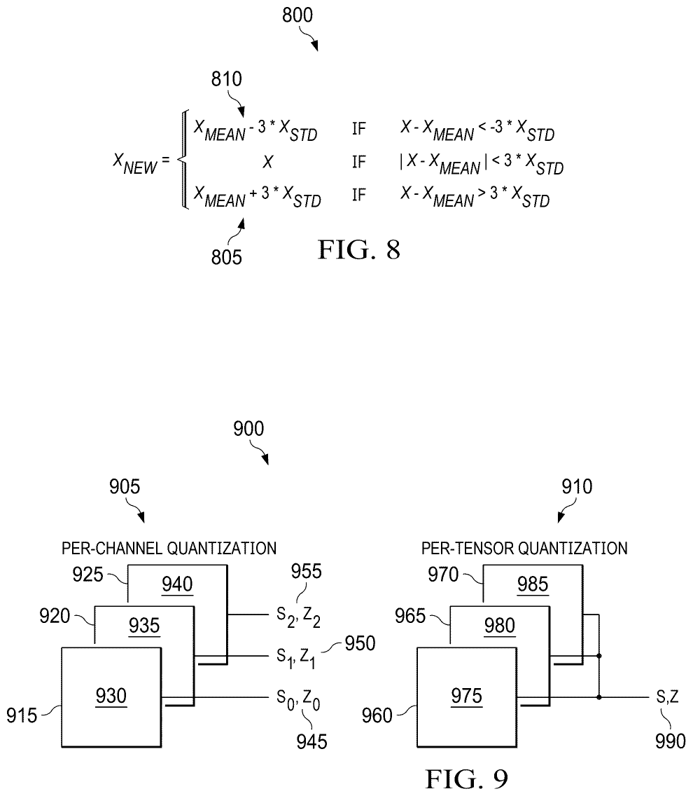

FIG. 9 illustrates two example quantization types 900 supported by the model quantizer circuitry 405 of FIG. 4. The example quantization types 900 include per-channel quantization 905 and per-tensor quantization 910. In some examples, the model quantizer circuitry 405 implements per-channel quantization 905 to quantize the weights for different channels of a given model layer independently. For example, the observed value clipping circuitry 494 clips the sets of weights of the different channels independently, and the model parameter quantization circuitry 496 determines separate quantization factors for the different sets of weights independently. The illustrated example of FIG. 9 depicts per-channel quantization 905 performed for three (3) channels 915, 920 and 925 having respective sets of weights 930, 935 and 940. The model parameter quantization circuitry 496 determines a first set of quantization factors 945 for the first set of weights 930 associated with the first channel 915, a second set of quantization factors 950 for the second set of weights 935 associated with the second channel 920, and a third set of quantization factors 955 for the third set of weights 940 associated with the third channel 925.

In some examples, the model quantizer circuitry 405 implements per-tensor quantization 910 to quantize the weights for all channels of a given model layer collectively. For example, the observed value clipping circuitry 494 clips the sets of weights of all channels together, and the model parameter quantization circuitry 496 determines one set of quantization factors to be applied to all weights of that layer. In some examples, the model quantizer circuitry 405 implements per-tensor quantization 910 to quantize the activations for all channels of a given model layer collectively. For example, the observed value clipping circuitry 494 clips the activations of all channels together, and the model parameter quantization circuitry 496 determines one set of quantization factors to be applied to all activations of that layer. The illustrated example of FIG. 9 depicts per-tensor quantization 910 performed for three (3) channels 960, 965 and 970 having respective sets of activations 975, 980 and 985. The model parameter quantization circuitry 496 determines a single set of quantization factors 990 for the three sets of activations.

In some examples, the trained floating-point machine learning model 410 is a transformer network that has outliers limited to activations in a few particular layers and/or channels of the transformer network. For example, outliers may be limited to the MLP branch of the transformer network. In some such examples, the observed value clipping circuitry 494 is configured to limit its clipping operations to those layers/channels.

Based on the foregoing description, in some examples, the observed value clipping circuitry 494 of the model quantizer circuitry 405 clips a value of an activation associated with a layer of a floating-point version of a machine learning model (e.g., the trained floating-point machine learning model 410) to determine a clipped value of the activation, with the value of the activation based on calibration data 455 applied to the floating-point version of the machine learning model. In some such examples, the model parameter quantization circuitry 496 of the model quantizer circuitry 405 determines, using the clipped value of the activation, a quantization factor (e.g., a quantization factor 600) to quantize activations associated with a corresponding layer of a fixed-point version of the machine learning model (e.g., the fixed-point machine learning model 415). In some such examples, the device configuration platform 425 configures the fixed-point version of the machine learning model on a target device 430 using the quantization factor.

In some examples, the model observation circuitry 492 initiates execution of the floating-point version of the machine learning model using the calibration data 455, and the observed value clipping circuitry 494 causes the clipped value of the activation to propagate to a subsequent layer of the floating-point version of the machine learning model during the execution.

In some examples, the activation is a first activation, and the model observation circuitry 492 observes values multiple activations associated with the layer of the floating-point version of the machine learning model, with the values of the multiple activations based on the calibration data 455 applied to the floating-point version of the machine learning model, and the multiple activations include the first activation. In some examples, the multiple activations correspond to a single channel associated with the layer of the floating-point version of the machine learning model. In some such examples, the observed value clipping circuitry 494 determines a metric using the values of the activations, and the observed value clipping circuitry 494 clips the value of the first activation using the metric. In some such examples, the observed value clipping circuitry 494 scales the metric to determine a scaled metric, and clips the value of the first activation using the scaled metric. In some such examples, the metric is a standard deviation of the values of activations. In some such examples, the observed value clipping circuitry 494 also determines a mean of the values of the activations, and clips the value of the first activation using the mean and the standard deviation multiplied by a number.

In some examples, the activation is a first activation, the quantization factor 600 includes a scale factor 605, and the observed value clipping circuitry 494 determines the scale factor 605 by (i) determining a range of observed values of multiple activations associated with the layer of the floating-point version of the machine learning model, with the observed values of the multiple activations based on the calibration data 455 applied to the floating-point version of the machine learning model, and the multiple activations including the first activation, and (iii) determining the scale factor 605 using a ratio of the range of observed values to a quantization range associated with the corresponding layer of the fixed-point version of the machine learning model. In some such examples, quantization factor 605 also includes an offset factor 610, and the observed value clipping circuitry 494 determines the offset factor 610 using a ratio of a first one of the observed values (e.g., a minimum observed value) to the scale factor 605.

In some examples the quantization factor 600 is a first quantization factor, and the model observation circuitry 492 observes values of a first set of weights associated with the layer of the floating-point version of the machine learning model, with the first set of weights corresponding to a single channel associated with the layer of the floating-point version of the machine learning model. In some such examples, the observed value clipping circuitry 494 clips a value of a first weight of the first set of weights using a metric (e.g., a standard deviation) to determine a clipped value of the first weight, with the metric based on the values of the first set of weights. In some such examples, the model parameter quantization circuitry 496 determines, using the clipped value of the first weight, a second quantization factor to be used to obtain a second set of quantized weights associated with the corresponding layer of the fixed-point version of the machine learning model.

In some examples, the floating-point version of the machine learning model is a floating-point version of a transformer network, the layer of the floating-point version of the machine learning model is a layer of the floating-point version of the transformer network. In some such examples, the layer of the floating-point version of the transformer network corresponds to one of (i) an output layer of a multi-layer perceptron, (ii) a first element-wise addition layer coupled to the output layer of the multi-layer perceptron, or (iii) a second element-wise addition layer coupled to the first element-wise addition layer.

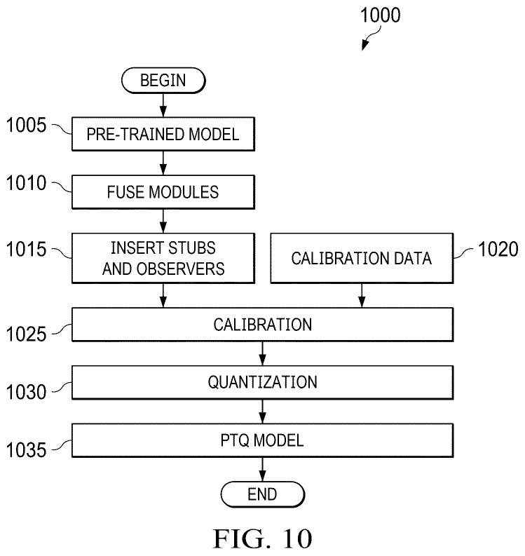

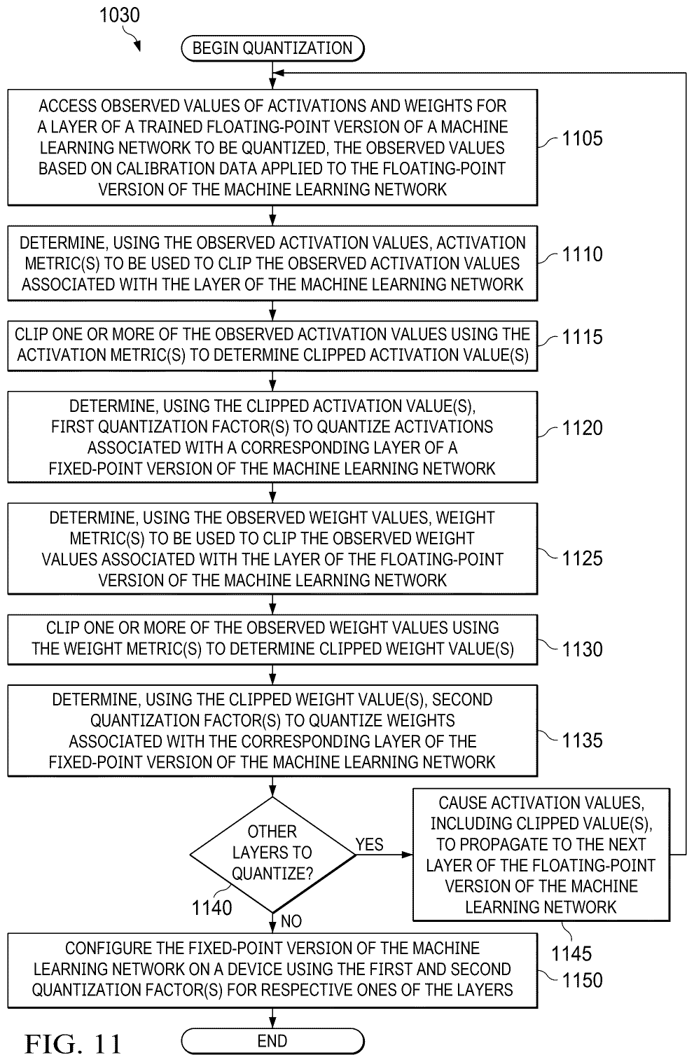

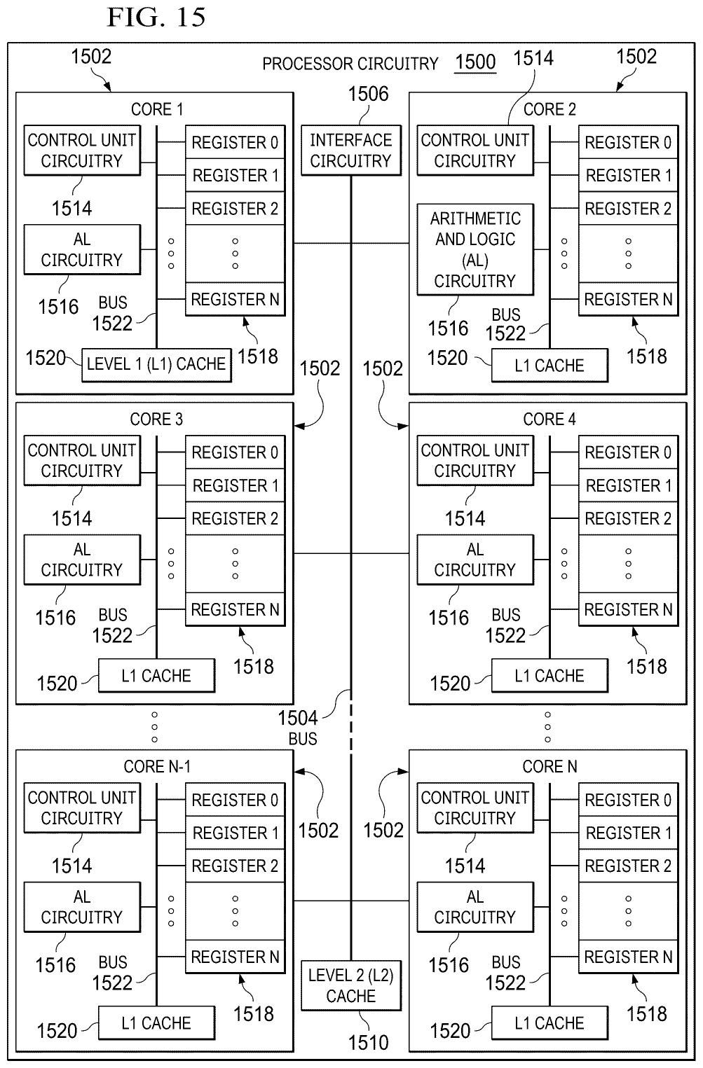

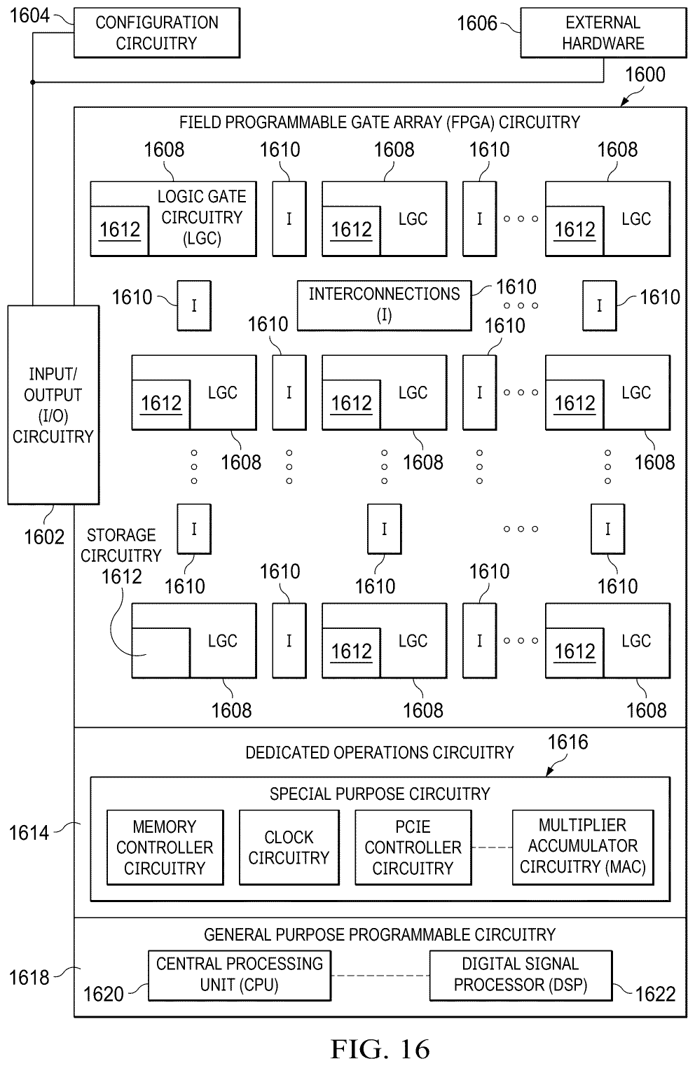

In some examples, the model quantizer circuitry 405 includes means for observing a machine learning model. For example, the means for observing may be implemented by the model observation circuitry 492. In some examples, the model observation circuitry 492 may be instantiated by programmable circuitry such as the example programmable circuitry 1412 of FIG. 14. For instance, the model observation circuitry 492 may be instantiated by the example microprocessor 1500 of FIG. 15 executing machine executable instructions such as those implemented by at least blocks 1005-1025 of FIG. 10 and block 1145 of FIG. 11. In some examples, the model observation circuitry 492 may be instantiated by hardware logic circuitry, which may be implemented by an ASIC, XPU, or the FPGA circuitry 1600 of FIG. 16 that are structured to perform operations corresponding to the machine-readable instructions. Also or alternatively, the model observation circuitry 492 may be instantiated by any other combination of hardware, software, or firmware. For example, the model observation circuitry 492 may be implemented by at least one or more hardware circuits (e.g., processor circuitry, discrete or integrated analog or digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

In some examples, the model quantizer circuitry 405 includes means for clipping observed model values. For example, the means for clipping may be implemented by the observed value clipping circuitry 494. In some examples, the observed value clipping circuitry 494 may be instantiated by programmable circuitry such as the example programmable circuitry 1412 of FIG. 14. For instance, the observed value clipping circuitry 494 may be instantiated by the example microprocessor 1500 of FIG. 15 executing machine executable instructions such as those implemented by at least block 1030 of FIG. 10 and blocks 1110, 1115, 1125, 1130 and 1145 of FIG. 11. In some examples, the observed value clipping circuitry 494 may be instantiated by hardware logic circuitry, which may be implemented by an ASIC, XPU, or the FPGA circuitry 1600 of FIG. 16 that are structured to perform operations corresponding to the machine-readable instructions. Also or alternatively, the observed value clipping circuitry 494 may be instantiated by any other combination of hardware, software, or firmware. For example, the observed value clipping circuitry 494 may be implemented by at least one or more hardware circuits (e.g., processor circuitry, discrete or integrated analog or digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

In some examples, the model quantizer circuitry 405 includes means for quantizing model parameters (e.g., activations and weights). For example, the means for quantizing model parameters may be implemented by the model parameter quantization circuitry 496. In some examples, the model parameter quantization circuitry 496 may be instantiated by programmable circuitry such as the example programmable circuitry 1412 of FIG. 14. For instance, the model parameter quantization circuitry 496 may be instantiated by the example microprocessor 1500 of FIG. 15 executing machine executable instructions such as those implemented by at least block 1030 of FIG. 10 and blocks 1120, 1135, and 1150 of FIG. 11. In some examples, the model parameter quantization circuitry 496 may be instantiated by hardware logic circuitry, which may be implemented by an ASIC, XPU, or the FPGA circuitry 1600 of FIG. 16 that are structured to perform operations corresponding to the machine-readable instructions. Also or alternatively, the model parameter quantization circuitry 496 may be instantiated by any other combination of hardware, software, or firmware. For example, the model parameter quantization circuitry 496 may be implemented by at least one or more hardware circuits (e.g., processor circuitry, discrete or integrated analog or digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

In some examples, the model quantizer circuitry 405 includes means for configuring a fixed-point machine learning model on a target device. For example, the means for configuring may be implemented by the device configuration platform 425. In some examples, the device configuration platform 425 may be instantiated by programmable circuitry such as the example programmable circuitry 1412 of FIG. 14. For instance, the device configuration platform 425 may be instantiated by the example microprocessor 1500 of FIG. 15 executing machine executable instructions such as those implemented by at least block 1030 of FIG. 10 and block 1150 of FIG. 11. In some examples, the device configuration platform 425 may be instantiated by hardware logic circuitry, which may be implemented by an ASIC, XPU, or the FPGA circuitry 1600 of FIG. 16 that are structured to perform operations corresponding to the machine-readable instructions. Also or alternatively, the device configuration platform 425 may be instantiated by any other combination of hardware, software, or firmware. For example, the device configuration platform 425 may be implemented by at least one or more hardware circuits (e.g., processor circuitry, discrete or integrated analog or digital circuitry, an FPGA, an ASIC, an XPU, a comparator, an operational-amplifier (op-amp), a logic circuit, etc.) configured or structured to execute some or all of the machine-readable instructions or to perform some or all of the operations corresponding to the machine-readable instructions without executing software or firmware, but other structures are likewise appropriate.

FIG. 10 is a flowchart representative of example machine-readable instructions and/or example operations 1000 that may be at least one of executed, instantiated, or performed by programmable circuitry to implement the model quantizer circuitry 405 of FIG. 4. The example machine-readable instructions and/or the example operations 1000 of FIG. 10 begin at block 1005 at which the model observation circuitry 492 of the model quantizer circuitry 405 accesses the trained floating-point machine learning model 410 to be quantized, as described above. At block 1010, the model observation circuitry 492 fuses modules of the trained floating-point machine learning model 410 that can be combined together without affecting the quantization of the trained floating-point machine learning model 410. At block 1015, the model observation circuitry 492 inserts observer operation and any other program code stubs into the trained floating-point machine learning model 410 to permit observation of the weights and activations of the various layers of the trained floating-point machine learning model 410, as described above.

At block 1020, the model observation circuitry 492 accesses calibration data 455, as described above. At block 1025, the model observation circuitry 492 causes the trained floating-point machine learning model 410 to execute (e.g., on the workstation 420) and process (e.g., perform inference on) the calibration data 455 to obtain observed values of the weights and activations of the various layers of the trained floating-point machine learning model 410, as described above. At block 1030, the observed value clipping circuitry 494 and the model parameter quantization circuitry 496 of the model quantizer circuitry 405 use the observed weight and activation values obtained at block 1025 to determine quantization factors 460 for quantizing the weights and activations of the various layers of the trained floating-point machine learning model 410, as described above. For example, at block 1025, the observed value clipping circuitry 494 and the model parameter quantization circuitry 496 may perform an enhanced PTQ procedure that uses clipped values of observed weights and activations obtained at block 1025. Example machine-readable instructions and/or example operations that may be used to perform the processing of block 1030 are illustrated in FIG. 11, which is described in detail below.

At block 1035, the model parameter quantization circuitry 496 outputs respective sets of quantization factors 460 to be used to quantize the respective sets of weights and the respective sets of activations at the various layers of the trained floating-point machine learning model 410, as described above. In some examples, the model parameter quantization circuitry 496 also uses the quantization factors 600 for the respective sets of weights at the various layers of the trained floating-point machine learning model 410 to quantize those weights and output respective sets of quantized weights 465 for the corresponding layers of the fixed-point machine learning model 415, as described above. In some examples, at block 1035, the device configuration platform 425 configures the fixed-point machine learning model 415 on a target device 430 using the quantization factors 460 and the quantized weights 465 for the various model layers, as described above. The example machine-readable instructions and/or example operations 1000 then end.

FIG. 11 is a flowchart representative of example machine-readable instructions and/or example operations 1030 that may be at least one of executed, instantiated, or performed by programmable circuitry to implement the processing performed by the model quantizer circuitry 405 at block 1030 of FIG. 10. The example machine-readable instructions and/or the example operations 1030 of FIG. 11 begin at block 1105 at which the observed value clipping circuitry 494 of the model quantizer circuitry 405 accesses observed values of the activations and weights for a given layer of the trained floating-point machine learning model 410, as described above. As also described above, the observed values of the activations and weights are based on calibration data 455 applied to the trained floating-point machine learning model 410 by the model observation circuitry 492 of the model quantizer circuitry 405.

At block 1110, the observed value clipping circuitry 494 determines, using the observed activation values, one or more activation metrics to be used to clip the observed activation values associated with the given layer of the trained floating-point machine learning model 410, as described above. For example, the activation metrics can be a standard deviation and a mean of the observed activation values, as described above. At block 1115, the observed value clipping circuitry 494 clips one or more of the observed activation values for the given model layer using the activation metric(s) determined at block 1110 to determine corresponding clipped activation value(s) for the given model layer, as described above. At block 1120, the model parameter quantization circuitry 496 of the model quantizer circuitry 405 determines, using the clipped activation value(s) for the given model layer, a first set of quantization factors to be used to quantize the activations associated with a corresponding layer of the fixed-point machine learning model 415, as described above.

At block 1125, the observed value clipping circuitry 494 determines, using the observed weight values, one or more weight metrics to be used to clip the observed weight values associated with the given layer of the trained floating-point machine learning model 410, as described above. For example, the weight metrics can be a standard deviation and a mean of the observed weight values, as described above. At block 1130, the observed value clipping circuitry 494 clips one or more of the observed weight values for the given model layer using the weight metric(s) determined at block 1125 to determine corresponding clipped weight value(s) for the given model layer, as described above. At block 1135, the model parameter quantization circuitry 496 determines, using the clipped weight value(s) for the given model layer, a second set of quantization factors to be used to quantize the weights associated with the corresponding layer of the fixed-point machine learning model 415, as described above.

At block 1140, the model quantizer circuitry 405 determines whether there are subsequent layers of the trained floating-point machine learning model 410 to be quantized. If there are subsequent model layers to be quantized (corresponding to the Yes output of block 1140), the model observation circuitry 492 and/or the observed value clipping circuitry 494 causes the observed activation values of the current layer, including any clipped activation values, to propagate to the next layer of the trained floating-point machine learning model 410, as described above. Processing then returns to block 1105 and blocks subsequent thereto to permit the weights and activations of the next model layer to be quantized. However, if there are no more model layers to be quantized (corresponding to the No output of block 1140), then at block 1150 the model parameter quantization circuitry 496 outputs the sets of quantization factors determined for the various layers of the trained floating-point machine learning model 410 and causes the device configuration platform 425 to use the sets of quantization factors to configure the fixed-point machine learning model 415 on the target device 430, as described above. The machine-readable instructions and/or the example operations 1030 then end.

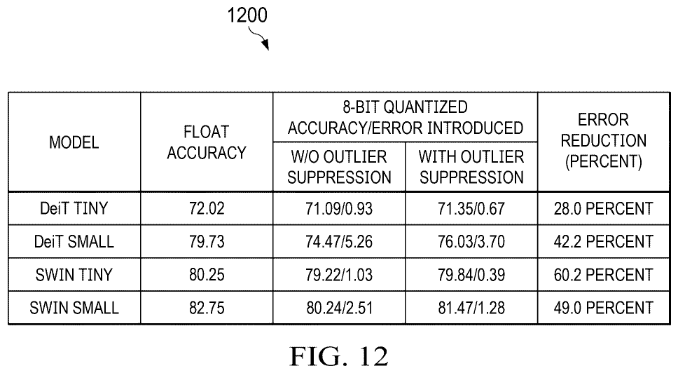

FIG. 12 illustrates example model quantization performance results 1200 achieved by the model quantizer circuitry 405 of FIG. 4 in the context of activation outlier removal. The results 1200 demonstrate that outlier clipping, also referred to as outlier suppression, performed on activation data by the model quantizer circuitry 405 increased quantized model accuracy and reduce quantized model error relative to other model quantization approaches that do not employ outlier clipping/suppression.

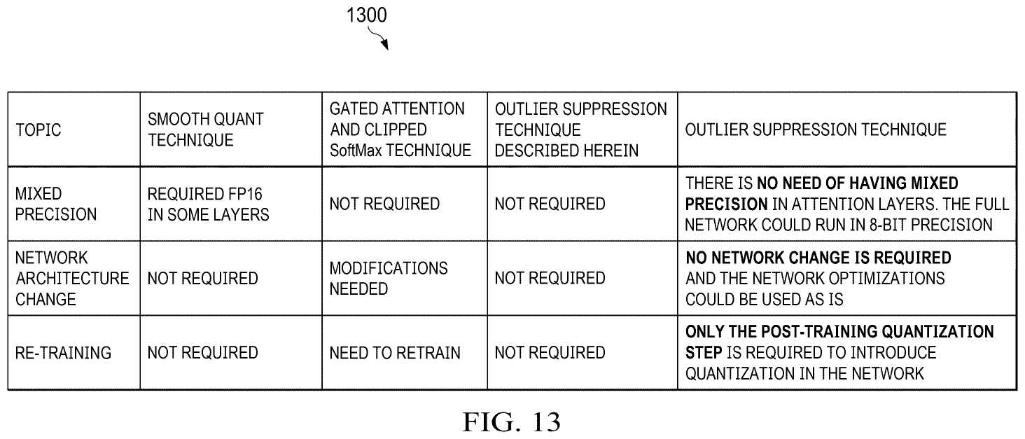

FIG. 13 illustrates example advantages 1300 of the model quantizer circuitry 405 of FIG. 4 relative to other model quantization approaches. The advantages 1300 include (i) avoiding the use of mixed precision and the associated increase in model size and complexity, (ii) not involving changes to the structure of the quantized machine learning model, and (iii) not involving retraining of the machine learning model.

FIG. 14 is a block diagram of an example programmable circuitry platform 1400 structured to one or a combination of execute or instantiate one or more of the example machine-readable instructions or the example operations of FIGS. 10-11 to implement the model quantizer circuitry 405 of FIG. 4. The programmable circuitry platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, or microcontrollers from any desired family or manufacturer. The programmable circuitry 1412 may be implemented by one or more semiconductor based (e.g., silicon based) devices. In this example, the programmable circuitry 1412 implements the example model observation circuitry 492, the example observed value clipping circuitry 494, the example model parameter quantization circuitry 496, the example device configuration platform 425 and, more generally, the example model quantizer circuitry 405.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1416 may be implemented by one or a combination of flash memory or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter one of or a combination of data or commands into the programmable circuitry 1412. The input device(s) 1422 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1424 are also connected to the interface circuitry 1420 of the illustrated example. The output device(s) 1424 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1420 of the illustrated example, thus, includes one of or a combination of a graphics driver card, a graphics driver chip, or graphics processor circuitry such as a GPU.

The interface circuitry 1420 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store one or more of firmware, software, or data. Examples of such mass storage discs or devices 1428 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1432, which may be implemented by the machine-readable instructions of FIGS. 10-11, may be stored in one of or a combination of the mass storage device 1428, in the volatile memory 1414, in the non-volatile memory 1416, or on at least one non-transitory computer readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 10-11 to effectively instantiate the circuitry of FIG. 2 as logic circuits to perform operations corresponding to those machine-readable instructions. In some such examples, the circuitry of FIG. 4 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine-readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine-readable instructions or operations represented by the flowcharts of FIGS. 10-11.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Also or alternatively, the first bus 1504 may be implemented by any other type of computing or electrical bus. The cores 1502 may obtain data, instructions, and signals from one or more external devices by example interface circuitry 1506. The cores 1502 may output data, instructions, and signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and instructions. Data and instructions may be transferred (e.g., shared) by one of or a combination of writing to or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic or logic operations on the data within the corresponding core 1502. The AL circuitry 1516 of some examples performs integer-based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 or, more generally, the microprocessor 1500 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 1500 is a semiconductor device fabricated to include many transistors interconnected to implement the structures described above in one or more integrated circuits (ICs) contained in one or more packages.

The microprocessor 1500 may include or cooperate with one or more accelerators (e.g., acceleration circuitry, hardware accelerators, etc.). In some examples, accelerators are implemented by logic circuitry to perform certain tasks more quickly and efficiently than can be done by a general-purpose processor. Examples of accelerators include ASICs and FPGAs such as those discussed herein. A GPU, DSP, or other programmable device can also be an accelerator. Accelerators may be on-board the microprocessor 1500, in the same chip package as the microprocessor 1500, or in one or more separate packages from the microprocessor 1500.

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine-readable instructions. However, once configured, the FPGA circuitry 1600 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine-readable instructions represented by the flowchart(s) of FIGS. 10-11 but whose interconnections and logic circuitry are fixed once fabricated), the FPGA circuitry 1600 of the example of FIG. 16 includes interconnections and logic circuitry that may be one of or a combination of configured, structured, programmed, and interconnected in different ways after fabrication to instantiate, for example, some or all of the operations/functions corresponding to the machine-readable instructions represented by the flowchart(s) of FIGS. 10-11. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 10-11. As such, the FPGA circuitry 1600 may be at least one of configured or structured to effectively instantiate some or all of the operations/functions corresponding to the machine-readable instructions of the flowchart(s) of FIGS. 10-11 as dedicated logic circuits to perform the operations/functions corresponding to those software instructions in a dedicated manner analogous to an ASIC. Therefore, the FPGA circuitry 1600 may perform the operations/functions corresponding to the some or all of the machine-readable instructions of FIGS. 10-11 faster than the general-purpose microprocessor can execute the same.

In the example of FIG. 16, the FPGA circuitry 1600 is at least one of configured or structured in response to being programmed (and/or reprogrammed one or more times) based on a binary file. In some examples, the binary file may be one of or both of compiled or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may at least one of access or load the binary file to cause the FPGA circuitry 1600 of FIG. 16 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1600 of FIG. 16 to at least one of configure or structure the FPGA circuitry 1600 of FIG. 16, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 1600 of FIG. 16 may at least one of access or load the binary file to cause the FPGA circuitry 1600 of FIG. 16 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 1600 of FIG. 16 to at least one of configure or structure the FPGA circuitry 1600 of FIG. 16, or portion(s) thereof.

The FPGA circuitry 1600 of FIG. 16, includes example input/output (I/O) circuitry 1602 to at least one of obtain or output data to/from at least one of example configuration circuitry 1604 or external hardware 1606. For example, the configuration circuitry 1604 may be implemented by interface circuitry that may obtain a binary file, which may be implemented by one or more of a bit stream, data, or machine-readable instructions, to configure the FPGA circuitry 1600, or portion(s) thereof. In some such examples, the configuration circuitry 1604 may obtain the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine-readable instructions of FIGS. 10-11 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of one of or a combination of the electrical structures or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 or an example DSP 1622. Other general purpose programmable circuitry 1618 may also or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may also be implemented by combining at least the example microprocessor 1500 of FIG. 15 and the example FPGA circuitry 1600 of FIG. 16. In some such hybrid examples, one or more cores 1502 of FIG. 15 may execute a first portion of the machine-readable instructions represented by the flowchart(s) of FIGS. 10-11 to perform first operation(s)/function(s), the FPGA circuitry 1600 of FIG. 16 may be at least one of configured or structured to perform second operation(s)/function(s) corresponding to a second portion of the machine-readable instructions represented by the flowcharts of FIGS. 10-11, and/or an ASIC may be at least one of configured or structured to perform third operation(s)/function(s) corresponding to a third portion of the machine-readable instructions represented by the flowcharts of FIGS. 10-11.

Some or all of the circuitry of FIG. 4 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be at least one of configured or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 1500 of FIG. 15 may execute machine-readable instructions in one or more threads executing concurrently and/or in series. In some examples, the FPGA circuitry 1600 of FIG. 16 may be at least one of configured or structured to carry out operations/functions concurrently and/or in series. Moreover, in some examples, some or all of the circuitry of FIG. 4 may be implemented within one or more virtual machines or containers executing on the microprocessor 1500 of FIG. 15.

In some examples, the programmable circuitry 1412 of FIG. 14 may be in one or more packages. For example, at least one of the microprocessor 1500 of FIG. 15 or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

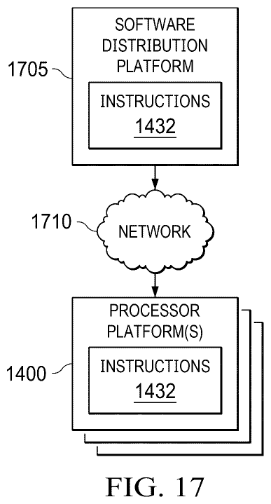

A block diagram illustrating an example software distribution platform 1705 to distribute software such as the example machine-readable instructions 1432 of FIG. 14 to other hardware devices (e.g., one or more hardware devices owned or operated by third parties from the owner or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity at least one of owning or operating the software distribution platform 1705. For example, the entity that at least one of owns or operates the software distribution platform 1705 may be at least one of a developer, a seller, or a licensor of software such as the example machine-readable instructions 1432 of FIG. 14. The third parties may be consumers, users, retailers, OEMs, etc., who one of or a combination of purchase or license the software for at least one of use, re-sale, or sub-licensing. In the illustrated example, the software distribution platform 1705 includes one or more servers and one or more storage devices. The storage devices store the machine-readable instructions 1432, which may correspond to the example machine-readable instructions of FIGS. 10-11, as described above. The one or more servers of the example software distribution platform 1705 are in communication with an example network 1710, which may correspond to any one or more of the Internet or any of the example networks described above. In some examples, the one or more servers are responsive to requests to transmit the software to a requesting party as part of a commercial transaction. Payment for at least one of the delivery, sale, or license of the software may be handled by the one or more servers of at least one of the software distribution platform or by a third-party payment entity. The servers enable one or more purchasers or licensors to download the machine-readable instructions 1432 from the software distribution platform 1705. For example, the software, which may correspond to the example machine-readable instructions of FIG. 10-11, may be downloaded to the example programmable circuitry platform 1400, which is to execute the machine-readable instructions 1432 to implement the model quantizer circuitry 405. In some examples, one or more servers of the software distribution platform 1705 periodically at least one of offer, transmit, or force updates to the software (e.g., the example machine-readable instructions 1432 of FIG. 14) to ensure improvements, patches, updates, etc., are distributed and applied to the software at the end user devices. Although referred to as software above, the distributed “software” could alternatively be firmware.

While an example manner of implementing the model quantizer circuitry 405 of FIG. 1 is illustrated in FIG. 4, one or more of the elements, processes, or devices illustrated in FIG. 4 may be combined, divided, re-arranged, omitted, eliminated, or implemented in any other way. Further, the example model observation circuitry 492, the example observed value clipping circuitry 494, the example model parameter quantization circuitry 496, the example device configuration platform 425, or, more generally, the example model quantizer circuitry 405 of FIG. 4, may be implemented by hardware alone or by hardware in combination with software and firmware. Thus, for example, any of the example model observation circuitry 492, the example observed value clipping circuitry 494, the example model parameter quantization circuitry 496, the example device configuration platform 425, or, more generally, the example model quantizer circuitry 405, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example model quantizer circuitry 405 of FIG. 4 may include one or more elements, processes, or devices in addition to, or instead of, those illustrated in FIG. 4, or may include more than one of any or all of the illustrated elements, processes and devices.

Flowchart(s) representative of example machine-readable instructions, which may be executed by programmable circuitry to at least one of implement or instantiate the model quantizer circuitry 405 of FIG. 4 or representative of example operations which may be performed by programmable circuitry to at least one of implement or instantiate the model quantizer circuitry 405 of FIG. 4, are shown in FIGS. 10-11. The machine-readable instructions may be one or more executable programs or portion(s) of one or more executable programs for execution by programmable circuitry such as the programmable circuitry 1412 shown in the example processor platform 1400 discussed below in connection with FIG. 14 and may be one or more function(s) or portion(s) of functions to be performed by the example programmable circuitry (e.g., an FPGA) discussed below in connection with FIG. 15 or 16. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 10-11, many other methods of implementing the example model quantizer circuitry 405 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 10-11 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that implement outlier removal for quantization of machine learning models, such as transformer networks. Described systems, apparatus, articles of manufacture, and methods improve the efficiency of a machine learning model implemented by a target device through removing outliers in the values of the floating-point machine learning model's weights and activations observed during quantization. By removing such outliers, the range of values to be represented by the fixed-point machine learning model's weights and activations on the target device is reduced. This can result in improved model error and/or model accuracy relative to other model quantization techniques. Described systems, apparatus, articles of manufacture, and methods are also directed to one or more improvement(s) in the operation of a machine such as a computer or other electronic device implementing a machine learning model.

Further examples and combinations thereof include the following. Example 1 includes a non-transitory computer-readable medium comprising computer readable instructions to cause at least one processor circuit to at least clip a value of an activation associated with a layer of a floating-point version of a machine learning model to determine a clipped value of the activation, the value of the activation based on calibration data applied to the floating-point version of the machine learning model, determine, using the clipped value of the activation, a quantization factor to quantize activations associated with a corresponding layer of a fixed-point version of the machine learning model, and configure the fixed-point version of the machine learning model on a device using the quantization factor.

Example 2 includes the non-transitory computer-readable medium of example 1, wherein the instructions are to cause one or more of the at least one processor circuit to initiate execution of the floating-point version of the machine learning model using the calibration data, and cause the clipped value of the activation to propagate to a subsequent layer of the floating-point version of the machine learning model during the execution.

Example 3 includes the non-transitory computer-readable medium of example 1, wherein the activation is a first activation, and the instructions are to cause one or more of the at least one processor circuit to observe values of a plurality of activations associated with the layer of the floating-point version of the machine learning model, the values of the plurality of activations based on the calibration data applied to the floating-point version of the machine learning model, the plurality of activations including the first activation, determine a metric using the values of the plurality of activations, and clip the value of the first activation using the metric.

Example 4 includes the non-transitory computer-readable medium of example 3, wherein the instructions are to cause one or more of the at least one processor circuit to scale the metric to determine a scaled metric, and clip the value of the first activation using the scaled metric.

Example 5 includes the non-transitory computer-readable medium of example 3, wherein the metric is a standard deviation of the values of the plurality of activations.

Example 6 includes the non-transitory computer-readable medium of example 5, wherein the instructions are to cause one or more of the at least one processor circuit to determine a mean of the values of the plurality of activations, and clip the value of the first activation using the mean and the standard deviation multiplied by a number.

Example 7 includes the non-transitory computer-readable medium of example 3, wherein the plurality of activations corresponds to a single channel associated with the layer of the floating-point version of the machine learning model.

Example 8 includes the non-transitory computer-readable medium of example 1, wherein the activation is a first activation, the quantization factor includes a scale factor, and the instructions are to cause one or more of the at least one processor circuit to determine the scale factor by determining a range of observed values of a plurality of activations associated with the layer of the floating-point version of the machine learning model, the observed values of the plurality of activations based on the calibration data applied to the floating-point version of the machine learning model, the plurality of activations including the first activation, and determining the scale factor using a ratio of the range of observed values to a quantization range associated with the corresponding layer of the fixed-point version of the machine learning model.

Example 9 includes the non-transitory computer-readable medium of example 8, wherein the quantization factor includes an offset factor, and the instructions are to cause one or more of the at least one processor circuit to determine the offset factor using a ratio of a first one of the observed values to the scale factor.

Example 10 includes the non-transitory computer-readable medium of example 1, wherein the quantization factor is a first quantization factor, and the instructions are to cause one or more of the at least one processor circuit to observe values of a first plurality of weights associated with the layer of the floating-point version of the machine learning model, the first plurality of weights corresponding to a single channel associated with the layer of the floating-point version of the machine learning model, clip a value of a first weight of the first plurality of weights using a metric to determine a clipped value of the first weight, the metric based on the values of the first plurality of weights, and determine, using the clipped value of the first weight, a second quantization factor to be used to obtain a second plurality of quantized weights associated with the corresponding layer of the fixed-point version of the machine learning model.

Example 11 includes the non-transitory computer-readable medium of example 1, wherein the floating-point version of the machine learning model is a floating-point version of a transformer network, the layer of the floating-point version of the machine learning model is a layer of the floating-point version of the transformer network, and the layer of the floating-point version of the transformer network corresponds to one of (i) an output layer of a multi-layer perceptron, (ii) a first element-wise addition layer coupled to the output layer of the multi-layer perceptron, or (iii) a second element-wise addition layer coupled to the first element-wise addition layer.

Example 12 includes an apparatus comprising interface circuitry, machine readable instructions, and at least one processor circuit to be programmed based on the machine readable instructions to clip a value of an activation associated with a layer of a floating-point version of a machine learning model to determine a clipped value of the activation, the value of the activation based on calibration data applied to the floating-point version of the machine learning model, determine, using the clipped value of the activation, a quantization factor to quantize activations associated with a corresponding layer of a fixed-point version of the machine learning model, and configure the fixed-point version of the machine learning model on a device using the quantization factor.

Example 13 includes the apparatus of example 12, wherein one or more of the at least one processor circuit is to initiate execution of the floating-point version of the machine learning model using the calibration data, and cause the clipped value of the activation to propagate to a subsequent layer of the floating-point version of the machine learning model during the execution.

Example 14 includes the apparatus of example 12, wherein the activation is a first activation, and one or more of the at least one processor circuit is to observe values of a plurality of activations associated with the layer of the floating-point version of the machine learning model, the values of the plurality of activations based on the calibration data applied to the floating-point version of the machine learning model, the plurality of activations including the first activation, determine a metric using the values of the plurality of activations, and clip the value of the first activation using the metric.

Example 15 includes the apparatus of example 14, wherein the metric is a standard deviation of the values of the plurality of activations, and one or more of the at least one processor circuit to determine a mean of the values of the plurality of activations, and clip the value of the first activation using the mean and the standard deviation multiplied by a number.

Example 16 includes the apparatus of example 12, wherein the activation is a first activation, the quantization factor includes a scale factor and an offset factor, and one or more of the at least one processor circuit is to determine the scale factor and the offset factor by determining a range of observed values of a plurality of activations associated with the layer of the floating-point version of the machine learning model, the observed values of the plurality of activations based on the calibration data applied to the floating-point version of the machine learning model, the plurality of activations including the first activation, determining the scale factor using a ratio of the range of observed values to a quantization range associated with the corresponding layer of the fixed-point version of the machine learning model, and determining the offset factor using a ratio of a first one of the observed values to the scale factor.

Example 17 includes a method comprising clipping a value of an activation associated with a layer of a floating-point version of a machine learning model to determine a clipped value of the activation, the value of the activation based on calibration data applied to the floating-point version of the machine learning model, determining, using the clipped value of the activation, a quantization factor to quantize activations associated with a corresponding layer of a fixed-point version of the machine learning model, and configuring the fixed-point version of the machine learning model on a device using the quantization factor.

Example 18 includes the method of example 17, including initiating execution of the floating-point version of the machine learning model using the calibration data, and causing the clipped value of the activation to propagate to a subsequent layer of the floating-point version of the machine learning model during the execution.

Example 19 includes the method of example 17, wherein the activation is a first activation, and including observing values of a plurality of activations associated with the layer of the floating-point version of the machine learning model, the values of the plurality of activations based on the calibration data applied to the floating-point version of the machine learning model, the plurality of activations including the first activation, determine a metric using the values of the plurality of activations, scaling the metric to determine a scaled metric, and clipping the value of the first activation using the scaled metric.

Example 20 includes the method of example 17, wherein the quantization factor is a first quantization factor, and including observing values of a first plurality of weights associated with the layer of the floating-point version of the machine learning model, the values of the first plurality of weights based on the calibration data applied to the floating-point version of the machine learning model, the first plurality of weights corresponding to a single channel associated with the layer of the floating-point version of the machine learning model, clipping a value of a first weight of the first plurality of weights using a metric to determine a clipped value of the first weight, the metric based on the values of the first plurality of weights, and determining, using the clipped value of the first weight, a second quantization factor to quantize a second plurality of weights associated with the corresponding layer of the fixed-point version of the machine learning model.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. A non-transitory computer-readable medium comprising computer-readable instructions to cause at least one processor circuit to at least:
clip a value of an activation associated with a layer of a floating-point version of a machine learning model to determine a clipped value of the activation, the value of the activation based on calibration data applied to the floating-point version of the machine learning model;
determine, using the clipped value of the activation, a quantization factor to quantize activations associated with a corresponding layer of a fixed-point version of the machine learning model; and
configure the fixed-point version of the machine learning model on a device using the quantization factor.

2. The non-transitory computer-readable medium of claim 1, wherein the instructions are to cause one or more of the at least one processor circuit to:
initiate execution of the floating-point version of the machine learning model using the calibration data; and
cause the clipped value of the activation to propagate to a subsequent layer of the floating-point version of the machine learning model during the execution.

3. The non-transitory computer-readable medium of claim 1, wherein the activation is a first activation, and the instructions are to cause one or more of the at least one processor circuit to:
observe values of a plurality of activations associated with the layer of the floating-point version of the machine learning model, the values of the plurality of activations based on the calibration data applied to the floating-point version of the machine learning model, the plurality of activations including the first activation;
determine a metric using the values of the plurality of activations; and
clip the value of the first activation using the metric.

4. The non-transitory computer-readable medium of claim 3, wherein the instructions are to cause one or more of the at least one processor circuit to:
scale the metric to determine a scaled metric; and
clip the value of the first activation using the scaled metric.

5. The non-transitory computer-readable medium of claim 3, wherein the metric is a standard deviation of the values of the plurality of activations.

6. The non-transitory computer-readable medium of claim 5, wherein the instructions are to cause one or more of the at least one processor circuit to:
determine a mean of the values of the plurality of activations; and
clip the value of the first activation using the mean and the standard deviation multiplied by a number.

7. The non-transitory computer-readable medium of claim 3, wherein the plurality of activations corresponds to a single channel associated with the layer of the floating-point version of the machine learning model.

8. The non-transitory computer-readable medium of claim 1, wherein the activation is a first activation, the quantization factor includes a scale factor, and the instructions are to cause one or more of the at least one processor circuit to determine the scale factor by:
determining a range of observed values of a plurality of activations associated with the layer of the floating-point version of the machine learning model, the observed values of the plurality of activations based on the calibration data applied to the floating-point version of the machine learning model, the plurality of activations including the first activation; and
determining the scale factor using a ratio of the range of observed values to a quantization range associated with the corresponding layer of the fixed-point version of the machine learning model.

9. The non-transitory computer-readable medium of claim 8, wherein the quantization factor includes an offset factor, and the instructions are to cause one or more of the at least one processor circuit to determine the offset factor using a ratio of a first one of the observed values to the scale factor.

10. The non-transitory computer-readable medium of claim 1, wherein the quantization factor is a first quantization factor, and the instructions are to cause one or more of the at least one processor circuit to:
observe values of a first plurality of weights associated with the layer of the floating-point version of the machine learning model, the first plurality of weights corresponding to a single channel associated with the layer of the floating-point version of the machine learning model;
clip a value of a first weight of the first plurality of weights using a metric to determine a clipped value of the first weight, the metric based on the values of the first plurality of weights; and
determine, using the clipped value of the first weight, a second quantization factor to be used to obtain a second plurality of quantized weights associated with the corresponding layer of the fixed-point version of the machine learning model.

11. The non-transitory computer-readable medium of claim 1, wherein the floating-point version of the machine learning model is a floating-point version of a transformer network, the layer of the floating-point version of the machine learning model is a layer of the floating-point version of the transformer network, and the layer of the floating-point version of the transformer network corresponds to one of (i) an output layer of a multi-layer perceptron, (ii) a first element-wise addition layer coupled to the output layer of the multi-layer perceptron, or (iii) a second element-wise addition layer coupled to the first element-wise addition layer.

12. An apparatus comprising:
interface circuitry;
machine-readable instructions; and
at least one processor circuit to be programmed based on the machine-readable instructions to:
clip a value of an activation associated with a layer of a floating-point version of a machine learning model to determine a clipped value of the activation, the value of the activation based on calibration data applied to the floating-point version of the machine learning model;
determine, using the clipped value of the activation, a quantization factor to quantize activations associated with a corresponding layer of a fixed-point version of the machine learning model; and
configure the fixed-point version of the machine learning model on a device using the quantization factor.

13. The apparatus of claim 12, wherein one or more of the at least one processor circuit is to:
initiate execution of the floating-point version of the machine learning model using the calibration data; and
cause the clipped value of the activation to propagate to a subsequent layer of the floating-point version of the machine learning model during the execution.

14. The apparatus of claim 12, wherein the activation is a first activation, and one or more of the at least one processor circuit is to:
observe values of a plurality of activations associated with the layer of the floating-point version of the machine learning model, the values of the plurality of activations based on the calibration data applied to the floating-point version of the machine learning model, the plurality of activations including the first activation;
determine a metric using the values of the plurality of activations; and
clip the value of the first activation using the metric.

15. The apparatus of claim 14, wherein the metric is a standard deviation of the values of the plurality of activations, and one or more of the at least one processor circuit to:
determine a mean of the values of the plurality of activations; and
clip the value of the first activation using the mean and the standard deviation multiplied by a number.

16. The apparatus of claim 12, wherein the activation is a first activation, the quantization factor includes a scale factor and an offset factor, and one or more of the at least one processor circuit is to determine the scale factor and the offset factor by:
determining a range of observed values of a plurality of activations associated with the layer of the floating-point version of the machine learning model, the observed values of the plurality of activations based on the calibration data applied to the floating-point version of the machine learning model, the plurality of activations including the first activation;
determining the scale factor using a ratio of the range of observed values to a quantization range associated with the corresponding layer of the fixed-point version of the machine learning model; and
determining the offset factor using a ratio of a first one of the observed values to the scale factor.

17. A method comprising:
clipping a value of an activation associated with a layer of a floating-point version of a machine learning model to determine a clipped value of the activation, the value of the activation based on calibration data applied to the floating-point version of the machine learning model;
determining, using the clipped value of the activation, a quantization factor to quantize activations associated with a corresponding layer of a fixed-point version of the machine learning model; and
configuring the fixed-point version of the machine learning model on a device using the quantization factor.

18. The method of claim 17, including:
initiating execution of the floating-point version of the machine learning model using the calibration data; and
causing the clipped value of the activation to propagate to a subsequent layer of the floating-point version of the machine learning model during the execution.

19. The method of claim 17, wherein the activation is a first activation, and including:
observing values of a plurality of activations associated with the layer of the floating-point version of the machine learning model, the values of the plurality of activations based on the calibration data applied to the floating-point version of the machine learning model, the plurality of activations including the first activation;
determine a metric using the values of the plurality of activations;
scaling the metric to determine a scaled metric; and
clipping the value of the first activation using the scaled metric.

20. The method of claim 17, wherein the quantization factor is a first quantization factor, and including:
observing values of a first plurality of weights associated with the layer of the floating-point version of the machine learning model, the values of the first plurality of weights based on the calibration data applied to the floating-point version of the machine learning model, the first plurality of weights corresponding to a single channel associated with the layer of the floating-point version of the machine learning model;
clipping a value of a first weight of the first plurality of weights using a metric to determine a clipped value of the first weight, the metric based on the values of the first plurality of weights; and
determining, using the clipped value of the first weight, a second quantization factor to quantize a second plurality of weights associated with the corresponding layer of the fixed-point version of the machine learning model.
